(19) United States
(12) Patent Application Publication
(10) Pub. No.: US 2013/0031211 A1
(43) Pub. Date: Jan. 31, 2013

(54) FEEDBACK ORIENTED PRIVATE OVERLAY NETWORK FOR CONTENT DISTRIBUTION

(71) Applicants: Dustin Johnson, Beverly Hills, CA (US); Ian Donahue, Beverly Hills, CA (US)

(72) Inventors: Dustin Johnson, Beverly Hills, CA (US); Ian Donahue, Beverly Hills, CA (US)

(21) Appl. No.: 13/361,927

(22) Filed: Jan. 30, 2012

Related U.S. Application Data
(60) Provisional application No. 61/437,590, filed on Jan. 29, 2011.

(51) Int. Cl. G06F 15/16

(52) U.S. Cl. 709/218

(57) ABSTRACT

A network of computers each serving as a “node” within a private, closed peer-to-peer network having a network administrator. Each node has a CPU and a hard drive, input/output device and connectivity to other nodes through the Internet. Each node is provided a hard drive (cache) to handle a multitude of data files. The cache supports multiple streams of fragments to multiple calling nodes without delay or deterioration of transfer rates. A plurality of metrics programs monitor the data demands on each node, the usage of each node's hard drive, and the transfer rates possible from the assigned node and provide that information to the network in a database available to all nodes. The network administrator, utilizing a contrarian selection method, pushes disaggregated data to the nodes in the network to evenly load data throughout the network and to fully load the node's hard drives.

### BACKGROUND OF THE INVENTION

The present invention relates to the field of content distribution, and more particularly content distribution systems designed as a feedback oriented private overlay network. The present invention is more particularly directed to system and methods for distributing content in a peer-to-peer network of user nodes using a contrarian selection method programmed into each user node on the network.

Online video consumption is currently growing at a fast rate and is expected to continue growing for the next several years. There are presently three main ways of content distribution and delivery known to handle that growth:

1. Fiber back—bone driven delivery—placing datacenters on major fiber optic lines—one company providing fiber back-bone driven content delivery is Limelight Networks;

2. Edge-caching—placing servers inside Internet Service Providers and allowing them to connect in a massive bandwidth overlay network regionally and globally—main company doing this is Akamai with Comcast, Time Warner, and other Internet providers heavily investing in their own edge solutions;

3. Adaptive stream—having a variety of different bitrate copies of a video file and using lower bitrate copies when the Internet connection slows or has problems—adaptive stream content distribution was first popularized by Move Networks, now owned by Echostar, and is currently being used widely.

Heretofore, all delivery platforms are focusing on a combination of these three solutions, with Google and Microsoft being the largest investors in this type of infrastructure play. Some companies are developing peer-to-peer (P2P) and variants of Multicast technology to create grid networks that support these investments in infrastructure.

Accordingly, there is a need for, and what was heretofore unavailable, a peer-to-peer network configured with nodes having a high end storage device (local) cache; wherein decisions are carried out not by servers but by devices at the nodes, and wherein such decisions affect and maintain the local, regional, and global integrity of a content distribution platform that will work across a multitude of different infrastructures operating Internet protocols. The present invention satisfies these needs and other deficiencies associated with prior art peer-to-peer networks.

### SUMMARY OF THE INVENTION

Briefly, and in general terms, the present invention is directed to a private overlay network that is configured to distribute massive data files to a multitude of end points (nodes) that both receive and send data. Data files are broken into thousands of data pieces, wherein the data pieces are disaggregated to nodes across the network and reaggregated just in time for the data files to be used by a node device. The disaggregation and reaggregation of data files happens in an emergent way on the network and is determined by a plurality of variables and endless [user determined] feedback loops that can be modified to increase performance or create new functions.

A function of the private overlay network of the present invention is to provide a complete home entertainment experience, wherein an end-user can access a nearly limitless amount of media content, instantly, at anytime, and with zero to extremely low reliance on central servers. The content distribution network of the present invention includes, but is not limited to:

(a) Plug and play infrastructure strategy—each of the three current content distribution networks (fiber back-bone, edge-caching, and adaptive stream) require investments in Internet Service Provider (ISP) infrastructure. The network of the present invention may be configured to operate across a multitude of different wire based or wireless based infrastructures, including, but not limited to, wire telephone lines, coaxial cable, and fiber optic systems, whereby the infrastructure supports some type of Internet protocol; and

(b) Singular live and archive solution—most technology developments for any type of grid (content distribution) network distinguishes between a live event stream and a video file that is archived. While the system of the present invention does distinguish between the two types of video files, the network includes a solution that automatically adjusts between the two types of video files.

A method of the present invention is directed to distributing content a in a peer-to-peer network of user nodes so as to provide a peer-to-peer network configured for distributing content using the Internet and having a plurality of nodes configured to receive and send content, each node being configured to act altruistically for the best interest of the network as a whole. The method of distributing content further includes providing the peer-to-peer network by configuring each node to act by favoring the stability of the network over its own performance interests. The method of the present invention provides video content for distribution using the peer-to-peer network and configuring at least one node to act by favoring the stability of the network over the performance interests of that one node. The method may include configuring at least one node to act by favoring the stability of the network rather than the direct self-interest of that one node.

The method of distributing content of the present invention may further include configuring each node with a potential of being similarly altruistic in the decision making by each node. The method of the present invention may include a pull mechanism, a data management mechanism, a data preparation mechanism and a push mechanism, wherein the pull mechanism is configured to provide each node the capability to process a request for data playback by an end user such that disaggregated data is aggregated just in time for playback, wherein the data management mechanism is configured for prioritizing information for deletion and, conversely, maintaining adequate redundancy by preventing deletion or triggering the push mechanism when applicable, wherein the data preparation mechanism is the step in the feedback loop that takes data from previous configurations and creates new optimized configurations for new data, and wherein the push mechanism is configured is responsible for disaggregating content across a private network.

The present invention further includes a system for distributing content a in a peer-to-peer network of user nodes. The peer-to-peer network is configured for distributing content using the Internet. The network includes a plurality of nodes configured to receive and send content, each node being configured to act altruistically for the best interest of the network as a whole. The system of the present invention is configured for distributing content, wherein the peer-to-peer network is configured such that each node acts to favor the stability of the network over its own performance interests.

Other features and advantages of the present invention will become apparent from the following detailed description, taken in conjunction with the accompanying drawings, which illustrate, by way of example, the features of the invention.

### BRIEF DESCRIPTION OF THE DRAWINGS

FIG. 1 is a schematic of a peer-to-peer overlay network for television through a set top box system.

FIG. 2A is a schematic depicting low redundancy in a peer selection content distribution network.

FIG. 2B is a schematic depicting how redundancy increases the usefulness of peer selection in accordance with the present invention.

FIG. 3 is a schematic depicting data fragments being aggregated in a “just in time” method.

FIG. 4 provides graphs depicting multiple bitrates utilizing a piece picker algorithm, including a line graph that shows how bandwidth may vary throughout a download.

FIG. 5 is a flowchart of a pull mechanism in accordance with the present invention.

FIG. 6 is a flowchart of a method for calculating a “priority mode” in accordance with the present invention.

FIG. 7 is a spreadsheet depicting high priority mode “peer selection” in accordance with the present invention, including data that a peer stores in its local database regarding other peers.

FIG. 8 is a spreadsheet depicting normal priority mode “peer selection” in accordance with the present invention, including data that a peer stores in its local database regarding other peers.

FIG. 9 is a spreadsheet depicting low priority mode “peer selection” in accordance with the present invention, including data that a peer stores in its local database regarding other peers.

FIG. 10 is a schematic depicting data fragments being aggregated in accordance with the present invention, wherein pieces of the file are assembled sequentially and are selected to be downloaded sequentially.

FIG. 11 provides graphs depicting a projected path of value decay for a piece of data in accordance with the present invention.

FIG. 12A is a graph depicting a path of value decay for a piece of a data file in accordance with the present invention.

FIG. 12B is a graph depicting how a scarcity floor works in accordance with the present invention.

FIG. 13A provides graphs depicting actual path of value decay for a piece of data having multiple boosts by external inputs in accordance with the present invention.

FIG. 13B provides bar charts depicting how data management values are sent to the global database in accordance with the present invention.

FIG. 14 is a spreadsheet depicting how “peer selection” is performed in accordance with a “push mechanism” of the present invention, including data that a peer would store in its local database about other peers.

FIG. 15 is a diagram depicting a benefit of using a “latency delta” to spread traffic (data) across a network in accordance with the present invention.

FIG. 16 is a diagram depicting feedback loops in accordance with the present invention.

FIG. 17 is a diagram showing a method of calculating connection data in accordance with the present invention.

### DETAILED DESCRIPTION OF THE INVENTION

As shown in the drawings for purposes of illustration, the present invention is directed content distribution, and more particularly content distribution systems designed as a feedback oriented private overlay network. The present invention is more particularly directed to system and methods for distributing content a in a peer-to-peer network of user nodes using a contrarian selection method programmed into each user node on the network.

The content distribution network (system) of the present invention is a network of computers, each serving as a node creating a private closed P2P network having a network administrator. Each node, or peer, has a central processing unit (CPU) and a hard drive, input/output means and connectivity to other nodes/peers through the Internet. Each node is assigned an extremely high cache to handle hundreds of very large data/media files. The cache supports multiple streams of fragments to multiple calling nodes without delay or deterioration of transfer rates.

The system of the present invention further includes a series of metrics that monitor the data demands on each node, the usage of each node's hard drive, and the transfer rates possible from each node. The system shares the monitored metrics using a database available to all nodes. A network administrator, through a series of algorithms, pushes fragmented or disaggregated data to the nodes in the overlay network to ensure data is loaded evenly throughout the network so as to fully load all hard drives of all nodes. The system may be configured to have all hard drives fully loaded with redundant disaggregated/fragmented copies of the entire media/data library, such that there is an abundance of options for a user at any node to call for or “pull” needed fragments for delivery “just-in-time” for use in a video stream.

The content distribution network of the present invention manages data pieces on the hard drives of the nodes through algorithms that track popularity/demand for the data. The system uses forecasting analyses to populate nodes with potentially high demand data. Each data piece may be tagged with a “popularity value” or “dispensability index,” and the data pieces with least or lowest values will be overwritten when new data is added to the network. In an embodiment of the present invention, if a “pull request” requires a data piece that can be delivered from an under-utilized remote node without compromising the stream, then the least active node will be used. The algorithms of the present invention spread pull requests throughout the network to reduce backlogs, provide consistently reliable operation, and increase utilization of available resources at the nodes.

In accordance with the present invention, a “push” of new data pieces and/or files also utilizes “popularity values” or a “dispensability index” to populate new high potentially demand data on nodes with the greatest amount of dispensable data pieces (i.e., the least popular data values) by overwriting (replacing) the dispensable data pieces with new data. This algorithm spreads the data pieces through the network regularly and continuously, balancing the data availability on all nodes and to all nodes.

The system of the present invention includes: (1) quality of service (QoS) for peer-to-peer delivered video playback; (2) flash crowd bottleneck prevention; (3) high levels of data redundancy on content storage and analytics; (4) extremely scalable; (5) extra cost savings on server infrastructure for a major IPTV broadcast system; (6) massive grid computing potential; (7) automation for complex systems; (8) central control of complex systems; (9) maximized bandwidth throughput; and (10) automatically optimizes for any Internet connection, for example, but not limited to, DSL, cable, optical fiber and mobile connections.

Turning now to the drawings, in which like reference numerals represent like or corresponding aspects of the drawings, the content distribution network of the present invention is broken into four interdependent processes that function as a closed loop. These interdependent processes are referred to herein as the Push Mechanism, the Pull Mechanism, the Data Management Mechanism, and the Data Preparation Mechanism.

The system of the present invention is configured to achieve: (1) storage of massive amounts of data; (2) delivery of massive amounts of data; and (3) collection of information that the system uses to improve network performance on the first two elements.

The Construction of the Network

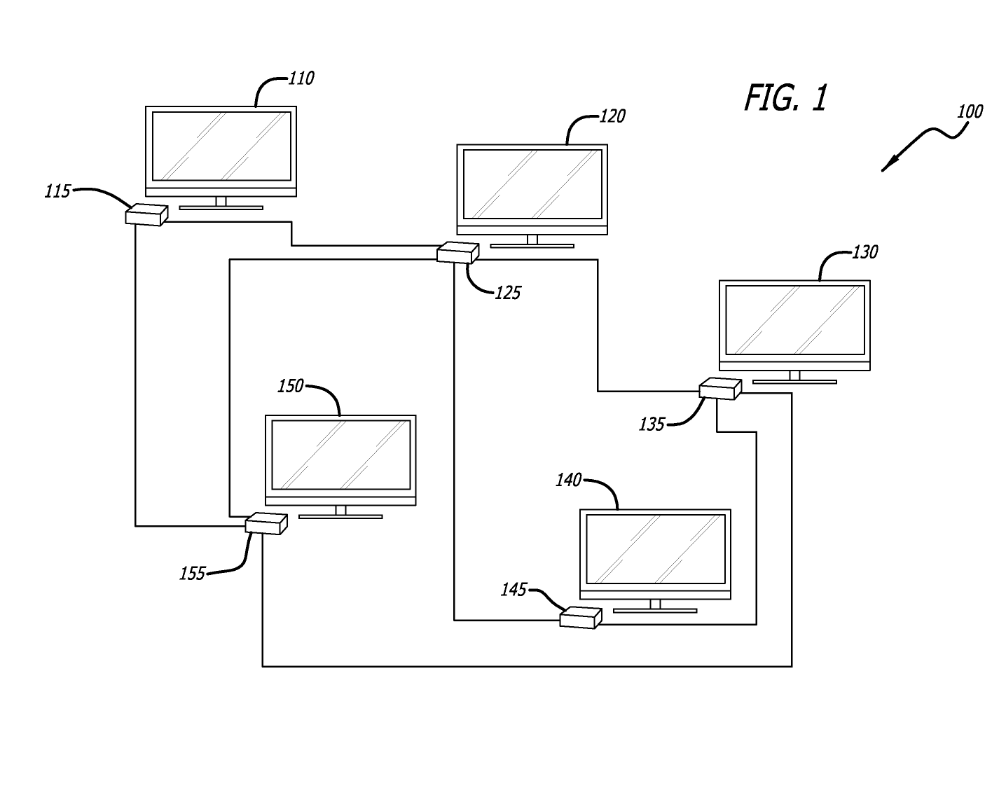

Referring now to FIG. 1, the system 100 of the present invention is configured with a massive network of hardware devices 110, 120, 130, 140, 150 that contain large dedicated hard disk caches 115, 125, 135, 145, 155. The system is further configured to process complex Internet routing and video decryption. One embodiment of the present invention includes a television (TV) set top box that could be located in a consumer's living room.

As shown in FIG. 1, the system of the present invention is in contrast to other peer-to-peer environments that run as software clients on non-dedicated devices. The network of the present invention may be configured to operate on dedicated television set top boxes placed near consumers' televisions inside a normal living room. The system of the present invention is also very different from central servers, edge computing, or cloud computing in the way that the hardware is distributed and managed.

Because the hardware devices of the present invention are intended to be located across a wide variety of highly variable Internet connections that vary in throughput, latency, traffic congestion, packet loss, and typically operate with dynamic IP addresses, the qualities of the connection from point A to point B (for example, a first 110 and a second 120 hardware device) on the network will vary greatly between point B and point C (for example, a second 120 and a third 130 hardware device), or even from point B to point A.

As used herein, “loosely connected” is used to describe the nature of the network 100 of the present invention, which in contrast to a cable operators broadcasting network or the cloud computing network of a CDN such as Amazon or Limelight [Netflix, Ultraviolet, Roku] in which there are dedicated cables connecting the devices that deliver relatively predictable connectivity with much higher throughput and much lower latency.

While the loosely connected network of the present invention may have a limited effect on the ability to deliver raw data, the inventive network does have a significant effect on the amount of time it takes to deliver that data and how much congestion the data causes. Buffering during streaming video or delaying playback to install proprietary software are unacceptable scenarios for modern commercial applications. This is why streaming video from central servers to an end user is the most common commercial solution for Internet video delivery.

In a network of “loosely connected” devices, it is very important where the data is stored. For this reason, the present invention provides a new automated processes for storing and distributing data in such a way as to take advantage of the strengths and weaknesses of just such a network of “loosely connected” devices.

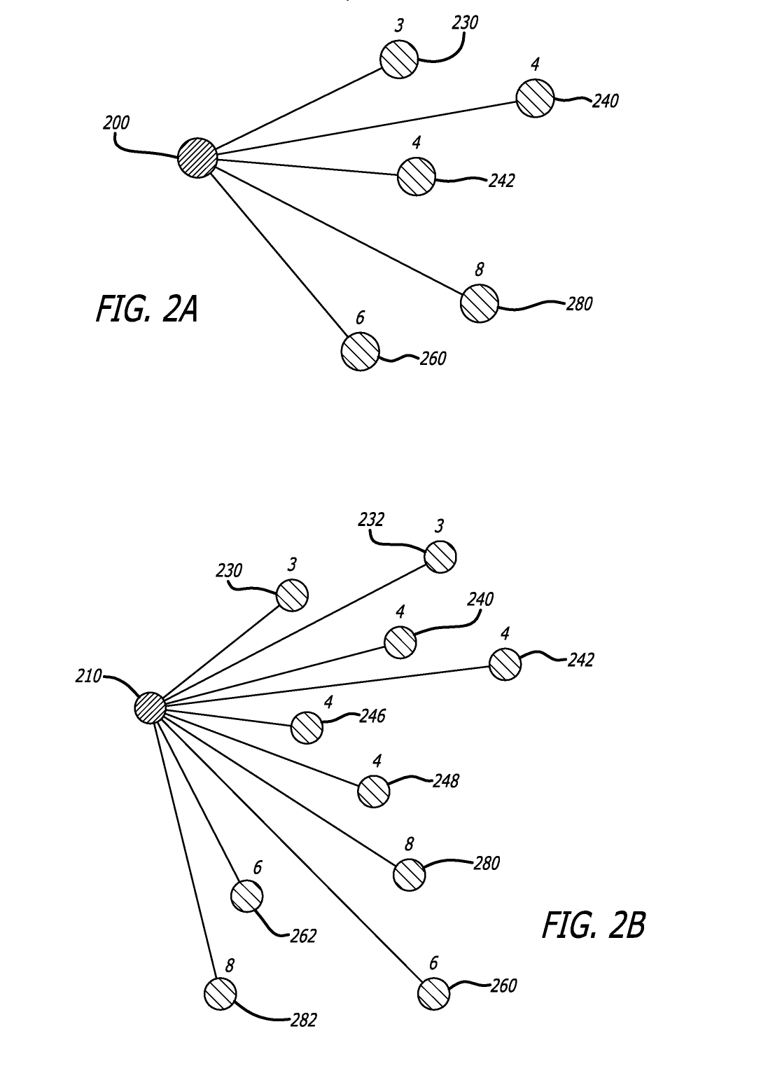

The core purpose of caching massive amounts of data on the networked devices is to increase the redundancy of the network to provide the maximum number of alternative paths, which creates better flexibility on the system (see FIG. 2). Without this new network design that maximizes the number of possible paths it would not be possible to create further efficiency by carefully analyzing and selecting the best possible path for each given situation because there would only be a small number of paths from which to choose. Without the need to deliver the data in real time, as in a streaming video application, there would also be no need to further increase the efficiency of this path selection for just in time delivery.

Referring to FIGS. 2A and 2B, the dark circles 200, 210 represents a peer trying to download data within a peer-to-peer overlay network. As shown in FIG. 2A, the download peer 200 has the option of five grey peers 230, 240, 242, 280, 260 from which to choose. If the Peer Number represents how ideal each peer is to connect to on a scale of 1 to 10, and the downloading peer can connect to three peers simultaneously, the downloading peer will process data using the nodes having Peer Numbers 8 (280), 6 (260) and 4 (240, 242), respectively. As shown in FIG. 2B, the network offers twice as many options, because each peer 210, 230, 232, 240, 242, 246, 248, 260, 262, 260, 282 has a larger cache and can therefore hold more redundant copies of each piece of data across the network 100 (see FIG. 1). As shown in FIG. 2A, even if the average distribution of ideal peers ranging from 1-10 is duplicated as shown in FIG. 2A such that there are the same proportion of Peer Numbers 3's, 4's, 6's, and 8's, the downloading peer 210 can chose a better combination of three peers from which to connect. In this preferable scenario, the downloading peer will process data using the nodes having Peer Numbers 8 (280, 282) and 6 (260 262).

In a commercial application, it is in the best interest of the operating party or administrator, to maintain a stable network in order to maximize the efficiency of the network. To this effect, the present invention has further improved upon the peer selection mechanism by preventing too many peering nodes from selecting the same best path at the same time by creating a feedback loop between nodes that keeps the best path open as often as possible to avoid congestion and overloading. This is fundamentally different than load balancing in traditional CDNs where downloading nodes contact a load-balancing switch to be rerouted to the appropriate server. In an embodiment of the system of the present invention 100, each individual downloading peer 200, 210 makes its own decisions about which other peers 230, 232, 240, 242, 246, 248, 260, 262, 260, 282 to which to connect, and there is no centralized load-balancing switch.

In accordance with the present invention, when a hardware device 110, 120, 130, 140, 150 is up and running and connected to the global Internet through virtually any public ISP, the device is available to the network for caching content, will automatically be used to store and distribute data, and will have all of the content on the network 100 available to download on demand.

The Main Moving Parts

The system of the present invention is configured to have four main sets of processes performed by each node on the network:

I. The Pull Mechanism, which is activated completely by user/end node demand that can be automated, but only for the purposes of pre-caching relevant content;

II. The Data Management Mechanism, which is running in the background of the node at all times;

III. The Data Preparation Mechanism, which is run on the network servers whenever new content/data is added to the network; and

IV. The Push Mechanism, which is triggered by the Data Management Mechanism to disaggregate content,

The system of the present invention includes two types of databases:

I. Local Database, which—kept by each node containing data about itself and other nodes it has connected to as well as what variables work best for its own performance; and

II. Global Database, which is a central data clearing house having:
A. data management information;
B. data fragment locations; and
C. sets network standards and conditions, including:
   1. administrator set variables, and
   2. automated artificial intelligence (AI) set variables.

In addition to a centralized service, the “Global Database” and some of its functions may be either carried out exclusively through a DHT style distributed database or redundantly mirrored on a DHT style distributed database. For more, see ADDITIONAL NOTES—“Alternative Distributed Architecture” herein.

I. Pull Mechanism

The Pull Mechanism is the driving force behind the network.

Basic Description

The network of the present invention is a TV broadcasting system for on demand or live video. When a user uses a computing device running the software of the present invention so as to watch TV, it triggers a number of processes that ultimately lead to seamless video playback on a digital screen.

The pull mechanism is the process by which each node processes a request for data playback by an end user such that disaggregated data is aggregated just in time for playback.

When a playback request is made, the node requests information from a global database regarding the identification of and the location of the fragments needed to assemble a stream for playback. When it has retrieved the list, it selects based on a complex algorithm, the best peers to download the fragments from (this is referred to as peer selection). It downloads from multiple peers simultaneously, gathering the data needed for playback in sequential or close to sequential order.

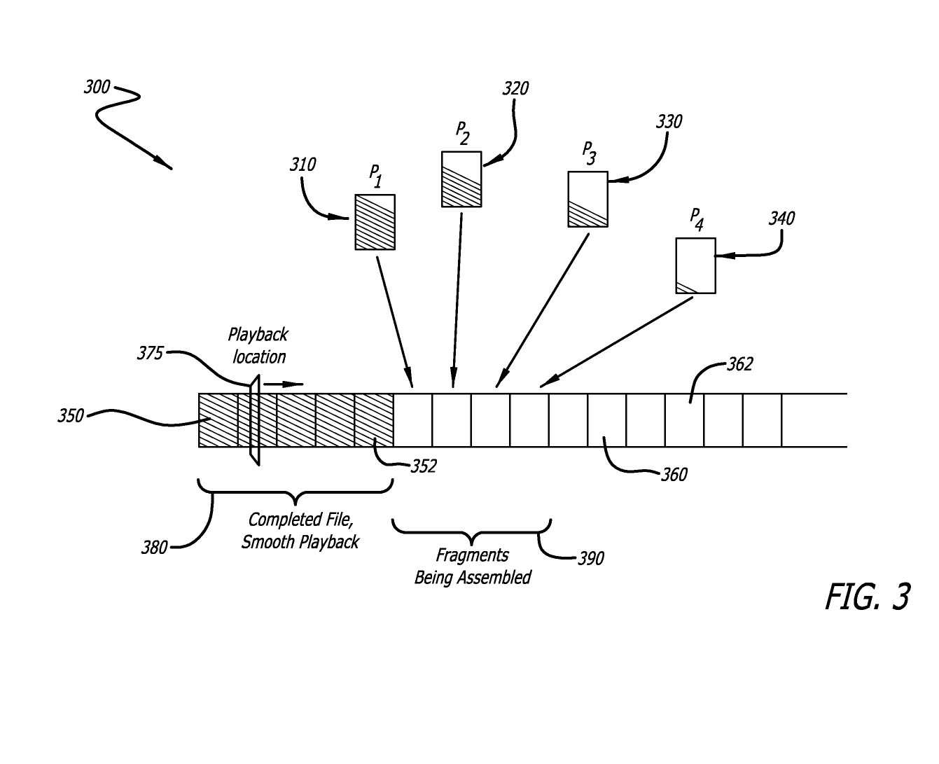

Referring now to FIG. 3, each peer 310, 320, 330, 340 downloads data from the network 300 on demand such that many pieces of a given media file are downloaded from many different sources. In this diagram, those sources are represented by peers referred to as P1, P2, P3, and P4. The “pieces” of the data file are represented by the boxes, whereby the dashed line filling the boxes 350, 352 represents information that has been downloaded and the empty white space in the boxes 360, 362 represents data that has not been downloaded. As the data is downloaded, it is assembled sequentially 390 such that as the “playback location” 375 moves along the timeline, the data around the “playback location” is already available as a completed file 380 and can be played back smoothly.

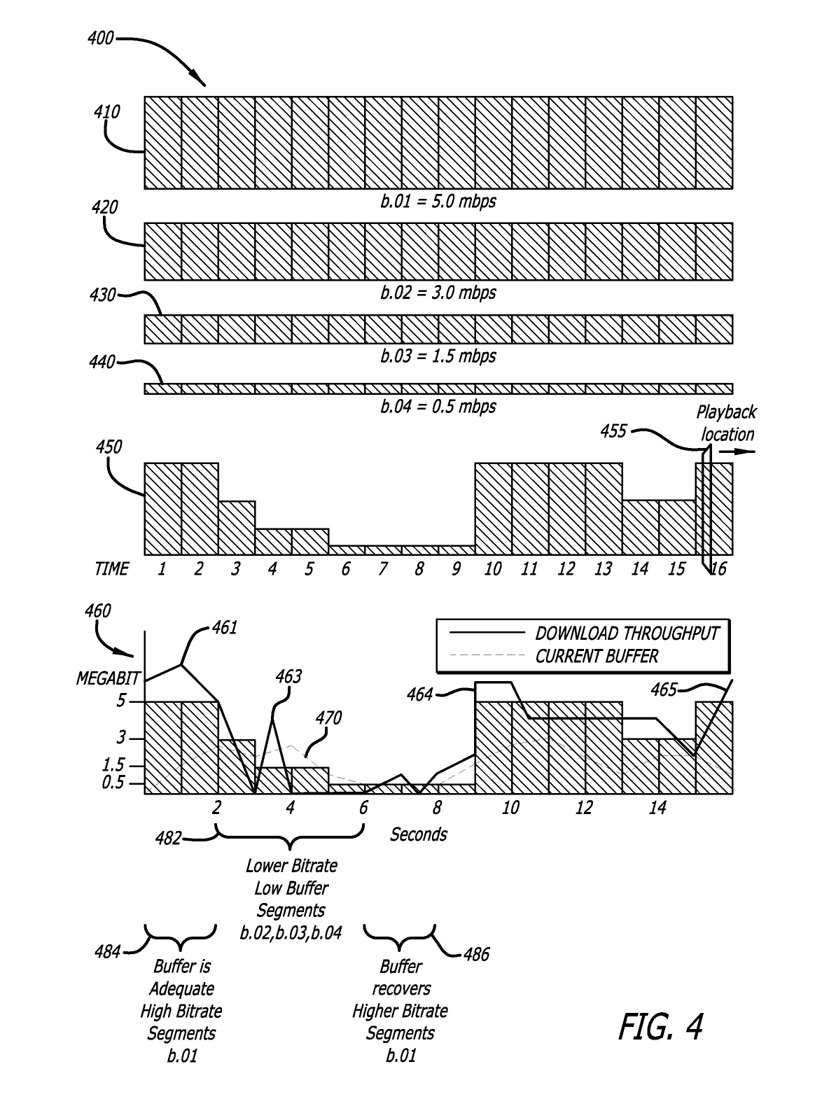

If the data type is streaming data, the playback device will have a number of different streams, sets of fragments with different bitrates 410, 420, 430, 440 to choose from amongst the fragments on the network that best match the current performance of the network connection (see FIG. 4).

The process 400 by which the Pull Mechanism determines the exact order of the fragments to download and the number of simultaneous downloads per fragment or per Pull operation may be referred to as the “Piece Picker Process,” which is further described in the ADDITIONAL NOTES herein.

As the content distribution network of the present invention downloads the data, it logs information about its connections in a local database and shares updated information with a global database. The data logged during this operation is very important and is used for decision-making processes in all other mechanisms including the Pull Mechanism itself.

The process of selecting peers when pulling data from the distributed network acts contrary to typical peer-to-peer or cloud networking. Each node prefers the lowest capacity connections, and only when most critical it then seek out the highest capacity connections. A number of other variables affect this decision and based on how critical a download is, either limits or allows the most popular peers on the network to be included in the peer selection set.

This algorithm requires methods for the following that are unique to this process:

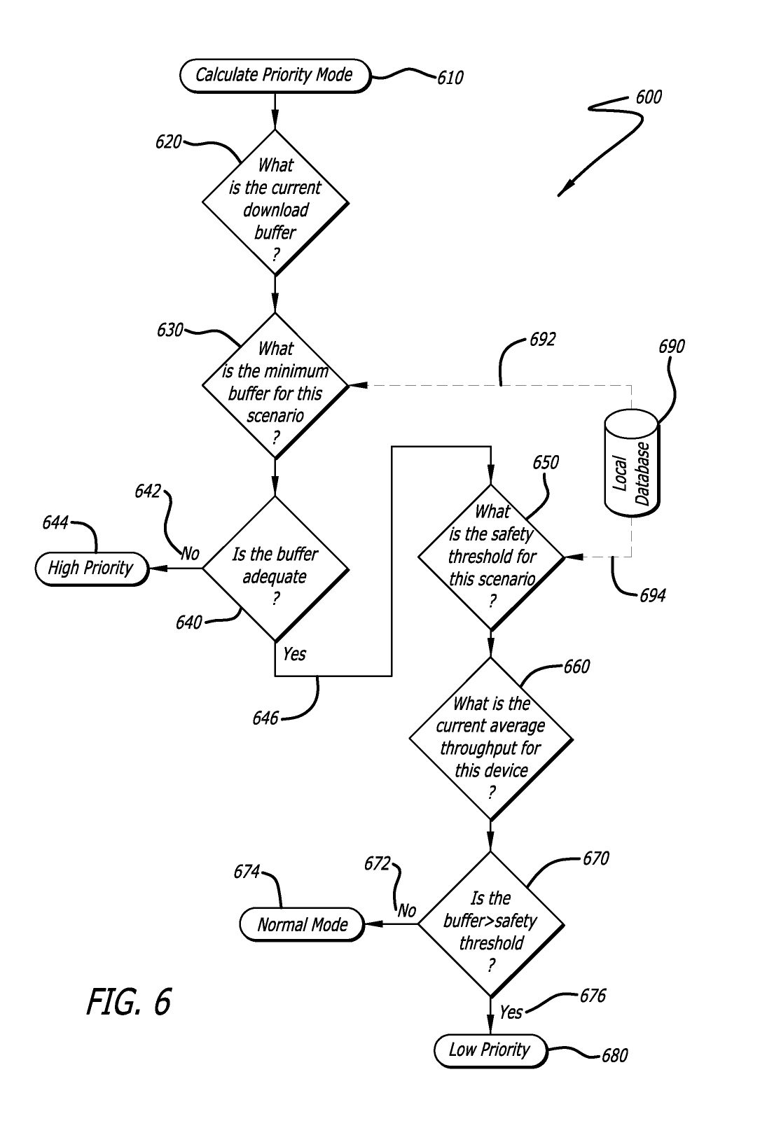

1. ranking and sorting peers based on their throughput, latency, and popularity (see FIG. 6);

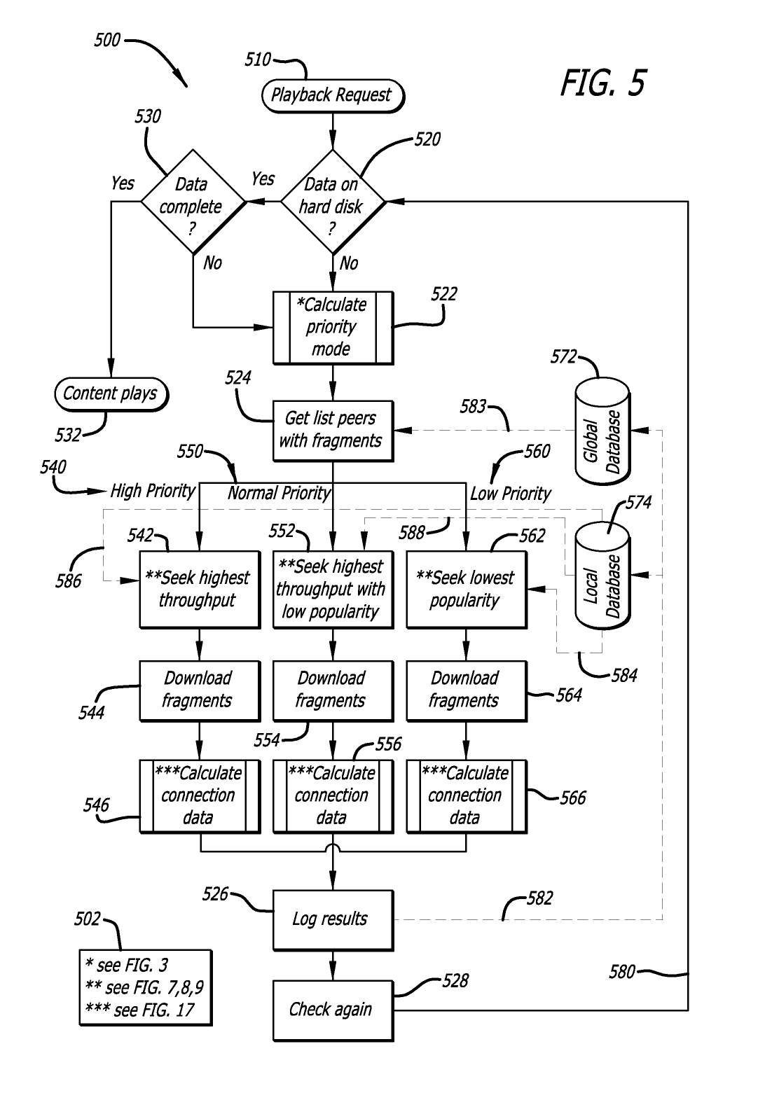

2. determining when it is critical and when it is not critical to connect to high capacity peers versus low capacity peers (see FIG. 5);

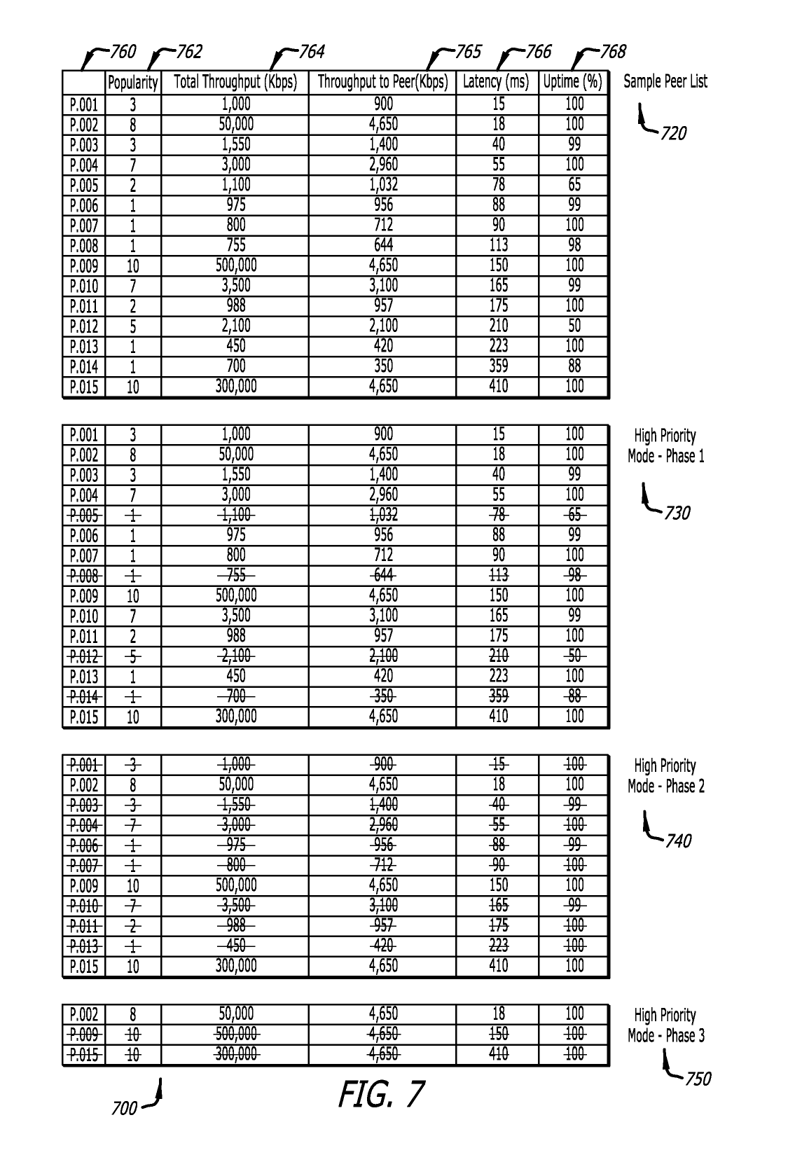

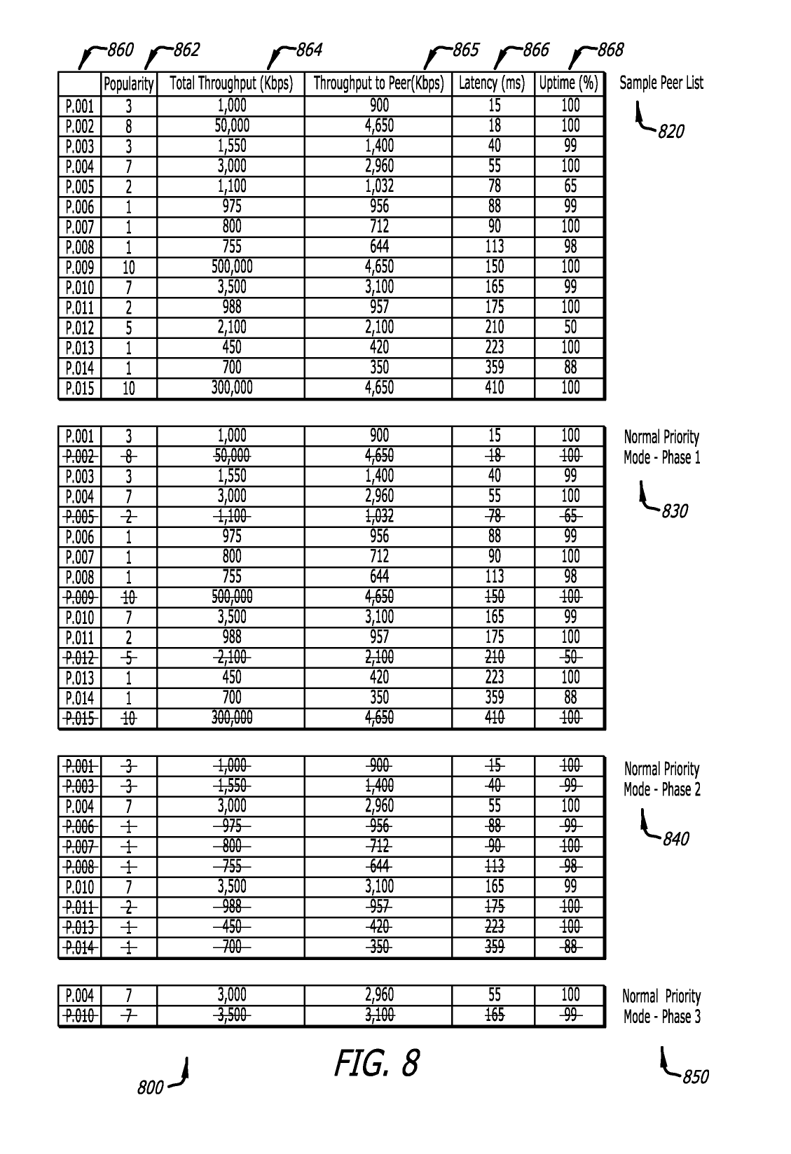

3. choosing to connect to the least popular peer without damaging real time QoS (Quality of Service/consistent video playback) (see FIG. 7 and FIG. 8);

4. selecting a bit rate less than current average throughput from the multiple bit rates created in Step 2 of the Push Mechanism; and

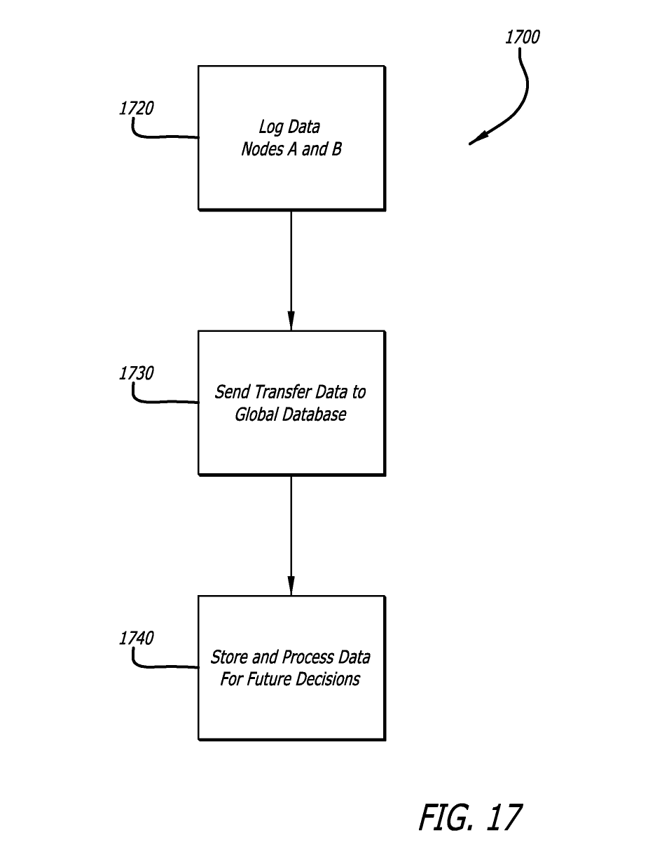

5. measuring and updating information about connection and use history and making it available to other peers (see FIG. 17).

Process Description:

1. When there is a request to access data through a node, either by an end user or by software automation, if the data requested is not stored locally on the node device, the node seeks the data from amongst the distributed network by referencing the global connection database to gather a list of the fragments needed and a set of possible locations for each fragment (see FIGS. 5-9).

1.1. One of the many functions of the global database is to function as an information clearinghouse. Data that peers need to share with other peers is stored there so that when peers need that data they can find it in a central location. As peers/nodes receive data either through a push or a pull, they update the global database so that the global database has a record for every file on the network. That record includes: which peers have the file, how many peers have the file, what the performance of that file has been during data transfers, what type of file is being recorded, how the performance of that file compares to other files of the same type, how the file is fragmented, an encryption map to verify the integrity of the data once it is delivered, and so on.

1.2. When a peer sends a request for the location of the file fragments it needs, the peer gets the most up to date version of the record described in “a” from the global database, specifically which peers have the necessary data, information of the structure of the data, and an encryption map to verify the integrity of that data once it is received. This is similar to a torrent file but with substantially more information. See the Data Preparation Mechanism description herein for more details.

1.3. If the data is streaming (for example, it has a native data rate or a time code such as video or audio), the transmission is carried out in real time such that the data rate (i.e., bit rate) and the transmission rate (i.e., download speed) are at least equal and that the fragments are gathered sequentially.

Each media file will have multiple versions encoded at different bit rates. See the Data Preparation Mechanism description herein for more details. Each peer keeps a record of its average throughput during pull operations such that it can anticipate its limitations and chooses to assemble fragments from the version encoded at the bit rate that is less than the average throughput. For example, if the available bit rates are six mbps, four mbps, and two mbps and the average throughput that the peer achieves during a pull operation is 5 mbps, then the peer will start with the 4 mbps stream. As the Pull Mechanism is carried out, the actual download speed for the current transfer will be used to determine which bit rate version the Piece Picker Process will chose for subsequent fragments.

2. Of the possible locations for each fragment identified by the Global Database, the node selects the most appropriate peer(s) to connect to based on the Peer Selection Algorithm.

2.1. The Peer Selection Algorithm monitors the buffer size as the file downloads during a pull operation. The buffer refers to the data that is downloaded prior to being needed and is measured in seconds where if the data rate were, for example 1 MB/s and 5 MB was downloaded ahead of the video playback the buffer size is five seconds.

2.2. Before selecting each peer to connect to, the peer executing the pull will compare the current buffer size to the adequate buffer range for that particular transfer. Based on whether the buffer is more than adequate, within the adequate range, or less than adequate, the peer selection algorithm will either proceed in low priority mode, normal mode, or high priority mode, respectively.

2.2.1. The adequate buffer size is a safe range of buffer sizes based on the downloading peers local database and is updated over time for each type of data transfer based on success rate. For example, a five mbps transfer on a given peer might require a minimum buffer of 5 seconds. If the buffer is less than that it triggers high priority mode, and if the buffer is greater than that, say fifteen seconds it is in normal mode. In addition to a minimum threshold, there is a safety threshold which for the same example could be thirty seconds. If the buffer exceeds the safe threshold, say thirty-five seconds, the peer selection algorithm triggers low priority mode.

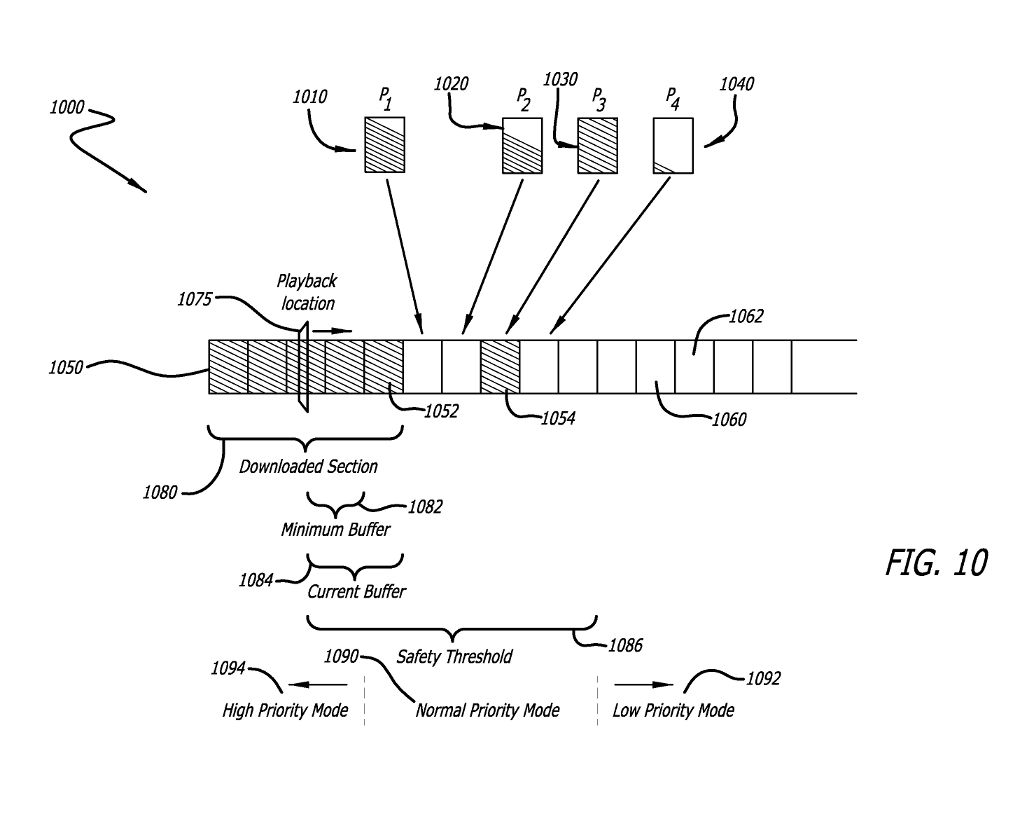

Referring now to FIG. 10, and with further reference to the sketch in FIGS. 3 and 4, the process 1000 is configured to assemble different pieces of data from four peers labeled P1 (1010), P2 (1020), P3 (1030), and P4 (1040). Just like the previous example (see FIG. 3), the pieces of the file are being downloaded simultaneously from multiple sources, and assembled just in time for playback, but in this example the download from peer P3 (1030) has finished and is placed in the timeline. This exemplifies the fact that while the pieces of the file are assembled sequentially and selected to be downloaded sequentially, the actual downloads may finish out of sequence.

As shown in FIG. 10, the “current buffer” 1084 is measured as the length of time between the “playback location” 1075 and the end of the “downloaded section” 1080. The process 1000 is a snapshot of a timeline and, at this particular moment in time, the “current buffer” 1084 is larger than the “minimum buffer” 1082 and less than the “safety threshold” 1086 so this download is in normal priority mode 1090. If the download from peer P1 (1010) did not finish by the time the “playback location” moved one or two squares to the right (1054, 1060), the “current buffer” would be less than the “minimum buffer” and the download would be in high priority mode 1084. On the other hand, if the download from P1 (1010), P2 (10210), and P4 (1040) finished before the playback 1075 moved one or two squares to the right, and additional pieces were also downloaded from either a yet to be seen peer Pn or again from the same set of peers P1-P4, then the “current buffer” would have expanded past the “safety threshold” and the download would be in low priority mode 1092.

2.2.2. The minimum buffer and safety threshold are different for different types of transfers (data rate, data type, individual peers, and potentially other variables). For example a 4 mbps data rate is more difficult for a peer with a normal throughput of 5 mbps to catch up to than a 2 mbps data rate, thus the minimum buffer and safety threshold may be smaller on the 2 mbps stream than the 4 mbps stream. The type of content might also affect it in that a TV show with commercial breaks will have built in pauses where the buffer can catch up by playing pre-cached content while a commercial free movie will not so the buffer on a movie should have a higher threshold.

2.2.3. The same transfer on a different peer (same bitrate, same file, etc.) might require a larger or smaller buffer depending on the performance of that peer over time. For example, a four mbps transfer on a peer with five mbps throughput will be more sensitive to fluctuations than the same four mbps transfer on a peer with an average throughput of twenty mbps and would require a different minimum buffer and safety threshold. For this reason the adequate buffer range is tracked locally by each peer for each peer not as a global variable.

2.2.4. Over time a peer may adjust the minimum buffer size that it uses for a given set of conditions. If there are too many playback interruptions, that is to say the playback of the video catches up to the downloaded data such that the buffer is zero and/or in a deficit, the minimum buffer can be increased so that the peer can connect to the best possible peers sooner, using high priority mode more effectively.

The threshold for this decision is set as a variable in the global database such that each peer is, for example, required to interrupt playback less than 0.01% of a transmission (99.99% up time). That is to say for a 30 minute TV show 0.18 seconds. If, for example, more than 0.18 seconds of playback interruption occurs per 30 minutes using the current minimum buffer threshold, it will be increased by a given interval which for example could be 5 seconds, so where peer “A” might have had a 5 second minimum buffer it now will have a 10 second minimum buffer. If that continues to fail to achieve 99.99% uninterrupted playback it may be moved to 15 seconds and so forth.

If over time, for a given peer for a given set of conditions finds that the buffer size leads to too many high priority transfers it will adjust the threshold. It can compare this to the global average for transfers for peers with similar speeds etc and if it is outside a set standard deviation from the normal distribution of high priority mode transfers, it will lower the minimum buffer if it has been maintaining successful playback well above the minimum success rate. Lowering the minimum buffer would cause connections to return to normal priority mode sooner and cause fewer high priority mode transfers.

2.3. Peer Selection—High Priority Mode—If the pull transfer is in high priority mode 700, the data needs to be delivered as quickly as possible because the main goal of high priority mode is to increase the buffer (see FIG. 7)

2.3.1. The Peer Selection algorithm first compares the list of peers 760 that have the needed fragments to the local database to see which peers have a connection history with the peer executing the pull.

2.3.2. The Peer Selection algorithm then eliminates unreliable peers (crossed off in FIG. 7) with low uptime 768 using a threshold value set at the global database.

2.3.3. The Peer Selection algorithm selects the peers that have the highest throughput 764.

2.3.4. If more than one available peer 760 has a throughput that exceeds the maximum throughput of the downloading peer, the Peer Selection algorithm will select the peer with the lowest latency within that group first to get the necessary fragments.

2.3.5. For example, if the Peer Selection algorithm finds that the highest throughput peer 760 in its local database that is known to have the necessary data has 50 mbps of throughput, it is likely to be a very popular peer on the network. In other modes the Peer Selection algorithm would ignore this peer because of the popularity 762, but in high priority mode 700, it will connect to this peer first regardless of popularity. However, if the maximum achievable throughput of the pulling peer is only five mbps, the algorithm may choose to connect to a similar peer with only 20 mbps of throughput but that has a lower latency than the 50 mbps peer. This method ensures that traffic is evenly spread geographically, that the connection is made as quickly as possible, and that all of the nodes on the network do not seek the same abnormally high throughput peers every time they enter high priority mode.

2.3.6. Note throughput 795 and latency 766 at first connection is sorted based on historic averages, but after connection is based on current performance so if a peer is busy or poorly connected it will not be treated as if it is the best peer but at the same time it won't be permanently down ranked for future use when it is not busy.

Referring further to FIG. 7, a “Sample Peer List” 720 is shown as spreadsheet representative of the data that a peer 760 would store in its local database about other peers. The downloading peer would compare the list it receives from the global database of peers that have a necessary piece of data and of those peers it would first reference those that it has a record with in its local database. In this example, the Peer Selection algorithm identifies the peers as P.001, P.002, P.003 and so forth. In reality the peer numbers would not be sequential and each peer would be identified by a much longer unique identifier that would be consistent across all databases. For this example, popularity ranges from 1-10 while in reality this range may be larger in scope and granularity.

As shown in FIG. 7, “High Priority Mode—Phase 1” 730 is based on a threshold in the local database, wherein the downloading peer eliminates options that do not have a high enough uptime percentage 768. In this example the Peer Selection algorithm eliminates anything with less than 99% uptime. “High Priority Mode—Phase 2” 740 is based on the shared data from each peer. The downloading peer looks for other peers that have a total upload throughput 764 that exceeds the total download throughput of the downloading peer. For this example, the total download throughput of the downloading peer is assumed to be 4,650 kbps and in this situation the peers it would select from would be P.002, P.009, and P.015. In “High Priority Mode—Phase 3” 750, the downloading peer selects the peer with the lowest latency 768 from the peers with the highest throughput 765. Accordingly, peer P.002 is selected.

2.4. Peer Selection—Normal Priority Mode—If the pull transfer is in normal priority mode 800, the goal is to get the data as quickly as possible without causing network congestion (see FIG. 8).

2.4.1. The Peer Selection algorithm first compares the list of peers 860 that have the needed fragments to the local database to see which peers have a connection history with the peer executing the pull.

2.4.2. To avoid network congestion, the Peer Selection algorithm does not connect the downloading peer to peers that exceed a popularity threshold.

2.4.2.1. Popularity 862 is “the likelihood a peer will be needed for a pull transfer.”

2.4.2.1.1. During a pull operation, the pulling peer will notify the uploading peer which priority mode it is in. The uploading peer will track over time, across all of its uploads, what proportion of its uploads is carried out in high priority mode. If the proportion is higher than the global average it will indicate that it is an important peer for emergency high priority connections.

2.4.2.1.2. Each time a peer connects to another peer during a new pull operation, the peer uploading to the peer executing the pull operation provides its shared information, which includes popularity among other things. This shared data can also be updated as a background process. As peers determine their local databases have out of date connection histories they may contact known peers for new up-to-date information.

2.4.2.1.3. Popularity could also take into account how many outbound seeds are already going at a given time. So as not to overload peers that might otherwise not have been historically popular but are popular right now.

2.4.2.1.4. There are a number of ways to quantify popularity rankings ranging from the sum of hours spent uploading to peers within a one week or twenty-four hour period where simultaneous connections count as multiple hours. Popularity rank could be a comparison of potential capacity versus used capacity or some simple measure of the volume or quantity of connections. These values could either be left as numerical data points to be compared by individual peers when selecting new connections, or could be compared to global averages and weighted based on that comparison. At the end of the day the goal here is the same; to determine how popular a peer is in such a way that it can be compared to other peers. Most likely this will initially be a simple measure of the volume of download requests in a twenty-four hour period or some other shorter or longer interval.

2.4.2.2. By avoiding peers that are too popular, the network traffic will be spread evenly across all peers. If there is less traffic, peers will all become less popular and if there is more traffic peers will all become more popular. Therefore, the popularity threshold is based on a comparison of the popularity of each peer to a global index kept at the global database that indicates where the cutoff should be made for filtering out peers that are too popular for a normal priority transfer.

2.4.2.3. At the global level this popularity threshold algorithm can adjust variables over time and measure their effects on the entire network traffic patterns to achieve optimization for certain goals such as avoiding buffering problems caused by congestion, minimizing the use of upload bandwidth on certain types of peers, increasing overall throughput, reducing fragment loss, etc

2.4.2.4. Information such as the threshold for filtering popular peers is periodically updated at the local level by requesting the data from the global database. If for whatever reason the global database becomes unreachable for a period of time, the peer can continue to use the cached information or revert to defaults programmed into the local database.

2.4.3. Referring further to FIG. 8, the Peer Selection algorithm is configured to obtain the data for the downloading peer as quickly as possible by avoiding peers with low up time 868, and by choosing the peers with the best throughput 864, 865 with prioritization for low latency 866.

2.4.3.1. This is the same algorithm 800 used by the Peer Selection algorithm as in high priority mode 700.

2.4.3.2. The Peer Selection algorithm first eliminates unreliable peers with low uptime 868.

2.4.3.3. The Peer Selection algorithm determines which peers exceed a maximum usable throughput 864, 865.

2.4.3.4. If any peers exceed a maximum usable throughput, then the Peer Selection algorithm connects the downloading peer to those uploading peers with the lowest latency 866.

2.4.3.5. If any peers exceed a maximum usable throughput, then the Peer Selection algorithm connects the downloading peer to those uploading peers with the highest throughput regardless of latency 866.

2.4.4. Note that throughput 864, 865 and latency 868 at the initial connection of a pull operation is sorted based on the historic data in the local connection database between two peers, but after the initial connection is based on current performance so if a peer is busy or poorly connected it will not be treated as if it is the best peer but at the same time it will not be permanently down ranked for future use when it is not busy. This ranking may be performed through a piece of shared data that signals that a peer is unusually busy, or could simply be averaged out against the fact that the number of good connections far outweighs the bad connections and if that is not the case then it is actually on average a bad connection.

Referring further the FIG. 8, a “Sample Peer List” ids depicted as a spreadsheet representative of the data that a peer would store in its local database about other peers. The downloading peer would compare the list it receives from the global database of peers that have a necessary piece of data and of those peers it would first reference those that it has a record with in its local database. In this example, the Peer Selection algorithm identifies the peers as P.001, P.002, P.003 and so forth. In reality, the peer numbers would not be sequential and each peer would be identified by a much longer unique ID that would be consistent across all databases. For this example, popularity ranges from 1-10 while in reality this range may be larger in scope and granularity.

As shown in FIG. 8, “Normal Priority Mode—Phase 1” 830 may be based on a threshold in the local database. The downloading peer eliminates uploading peers that do not have a high enough uptime percentage 868. In this example, the Peer Selection algorithm eliminates anything with less than 75% uptime. More importantly, it also eliminates peers that exceed a “Popularity Threshold” set by the global database. In this scenario, the threshold is 8. In “Normal Priority Mode—Phase 2” 840, the Peer Selection algorithm determines from the peers not eliminated in Phase 1 the peer with the highest throughput 865 to the peer. In this case it would be P.010. If, however, more than one peer remains in the list that has an upload throughput that exceeds the bit rate for the current download, the Peer Selection algorithm further filters in Phase 3 between those peers. For this example the bit rate is 2,500 kbps. In “Normal Priority Mode—Phase 3” 840, using the peers with the highest throughput, the Peer Selection algorithm selects the peer with the lowest latency 868. Accordingly, peer P.004 is selected.

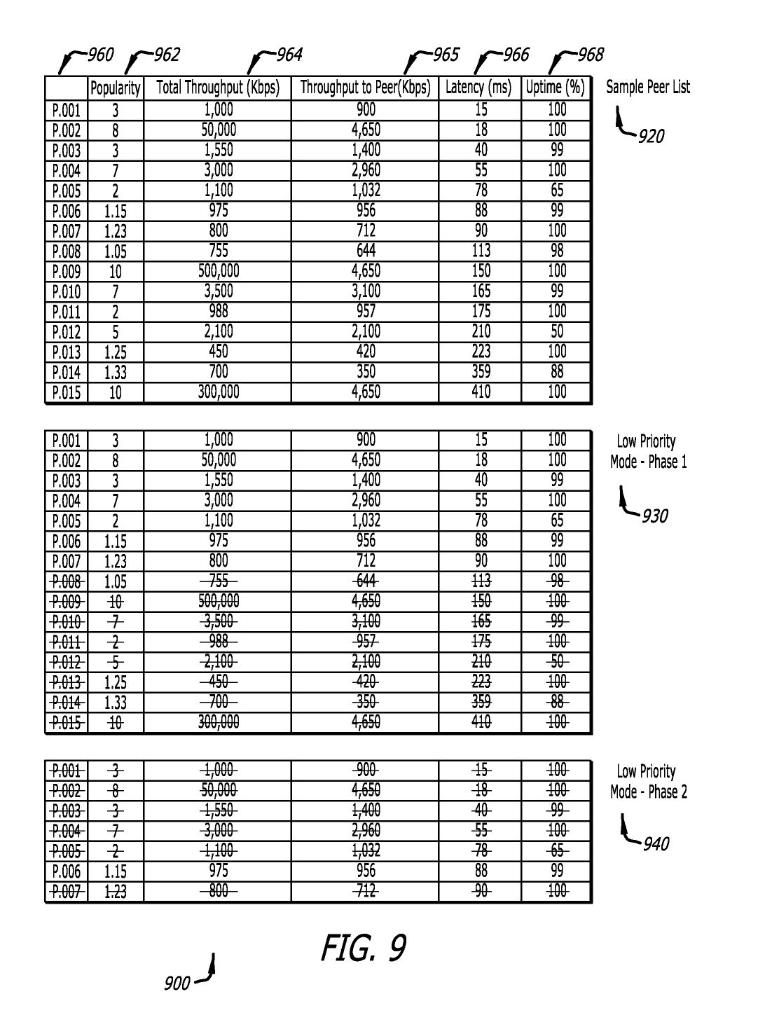

2.5. Peer Selection—Low Priority Mode—If the pull transfer is in low priority mode 900, the data is ahead of schedule, and the goal is to utilize the least utilized parts of the network to make up for the bias in high and normal modes to high throughput low latency connections (see FIG. 9).

2.5.1. Of the peers 960 that have the needed fragments based on information from the global connection database, the downloading peer seeks the uploading peers with the lowest popularity 962, even if they have a low up time 968, a low throughput 964, 965 and perhaps a high latency 968.

2.5.2. Within this selection process 900, there may be thresholds based on latency 968 to encourage the discovery of more “local” peers 960. This may function such that a downloading peer will limit its list of uploading peers with low popularity to those that have less than fifty milliseconds (ms) of latency, but if that limitation results in a list of only two to three peers, it may not be an adequate pool to select from so there may be a requirement for the filter to result in at least X number of choices or X % of the known options. So in this scenario the list might be limited to one-hundred ms where there may be twenty to thirty peers to choose from and this may either be adequate or inadequate, in which case it may raise to one hundred-fifty ms yielding say one-hundred to two-hundred peers, which may or may not be adequate and so forth. Once the proper narrowing has been done, the final selection is still based on the lowest popularity 962 within that group of uploading peers.

Referring further to FIG. 9, a “Sample Peer List” 920 is shown as a spreadsheet representative of the data that a peer 960 may store in its local database regarding other peers. The downloading peer would compare (a) the list it retrieves from the global database directed to any uploading peers that have a necessary piece of data against (b) those uploading peers the downloading peer would otherwise first reference based on a record with in the local database of the downloading peer. In “Low Priority Mode—Phase 1” 930, the downloading peer applies a latency threshold to keep the traffic local. In this example, the downloading peer eliminates peers with latency 966 above one-hundred ms. If this filter, however, limited the selection to an extent such that there were not enough remaining peers to make a good peer selection, the Peer Selection algorithm would apply a more generous filter of one-hundred-fifty (150) ms or two-hundred ms and so forth. Alternatively, this step could be skipped altogether for simplicity. In low priority mode, filtration for uptime reliability 968 may not be necessarily performed. In this example, the Peer Selection algorithm operating in the downloading peer identifies the suitable uploading peers as P.001, P.002, P.003 and so forth. In reality, the peer numbers would not be sequential, and each peer would be identified by a much longer unique ID that would be consistent across all databases. For this example, popularity 962 range from 1-10 has been made more precise within the range from 1-2 with P.006-P.008 and P.013-P.014 to show the effects of further granularity. In “Low Priority Mode—Phase 2” 940, the peer with the lowest popularity, P.006, is selected.

If the assumed data rate of the media file is 2,500 kbps as in FIG. 8, then connecting just to P.006 will likely only provide 956 kbps of throughput, a lot less than is needed to keep up with the media playback speed. In general it is assumed that the downloading peer will connect to as many peers as it needs to in order to max out its download throughput. This may be done with a single peer or may be done with hundreds of peers. In this example, the downloading peer would repeat the filtering process, finally selecting P.007 and then P.005 to reach a total throughput of 2,700 kbps. In order to get up to full download speed, the downloading peer would then continue to connect to more peers. At some point, the downloading peer would probably use a different latency threshold so that it could select peers P.008, P.013 and P.014. Such a selection may be preferred due to the lower popularity of P.001 or P.003, which would be next in line if the latency threshold was not raised.

2.5.3. A downloading peer being in “low priority mode” 900 provides an opportunity to establish connection histories with unknown uploading peers. A portion of the connections made in low priority mode will be with peers that are listed in the global connection database as having the necessary data fragments, but that are deliberately unknown to the downloading peer. If this leads to the discovery of popular peers or peers that are outside of the latency filters, those peers will be recorded to the local database, but will be reserved for normal and high priority connections after downloading the initial data fragment(s).

2.6. If the transfer is stuck in a failed state or if switching to high priority mode connections does not relieve buffering problems, that is to say the current throughput is less than the necessary throughput for the current bit rate version of the media file, the peer selection algorithm will switch to peers that have a lower bit rate version of the media, such that the current throughput performance is not less than the bit rate of the new media fragments being targeted by the pull mechanism (see FIG. 4).

2.7. If the current maximum throughput of the peer during the pull operation is less than the minimum bit rate of the media being sought and the buffer has been depleted, the transfer will be considered a failure and the device will switch to playing pre-cached content until the throughput can exceed the minimum throughput required to play streaming content, or troubleshooting will have to occur to examine the Internet connection of the end device.

3. Initial data that is collected when first connecting to a peer is the data that that peer knows about itself on average in relation to all other peers it has connected to. This is sometimes referred to as “shared data.” It includes but is not limited to:

3.1. The popularity of the peer

3.2. The average up time of the peer over time

3.3. The average throughput of the peer when uploading to other peers

3.4. The average latency of the peer to other peers on the network

4. As peers transfer data in a pull operation, each peer records information about the connection. The downloading peer records that data to specifically measure and keep track of the qualities of the connection with the uploading peer to be used in future peer selection calculations. The uploading peer records data as part of the larger data set establishing its known average connection potential, namely, upload throughput, latency, and popularity. This data is the “shared data” used in an initial connection and to share up to date information about popularity with downloading peers.

5. In addition to monitoring connections, each peer tracks the usage and locations of data fragments and reports this information to the global database. See “ADDITIONAL NOTES Note on Granularity of Global Database for Fragment Locations” herein.

5.1. Each peer keeps an up to date record of the data fragments it is storing and shares that information with the global database. The global database uses that information to inform other peers seeking that data where to find it. In addition to that, the reported information is used to determine the scarcity of data, a key factor in the data management mechanism discussed later.

5.2. This data may be as broad as a given film title or as granular as a two megabyte (mb) block of an mpeg stream.

II. Data Management Mechanism

The Data Management Mechanism of the present invention is responsible for prioritizing information for deletion and, conversely, maintaining adequate redundancy by preventing deletion or triggering the Push Mechanism when applicable.

Basic Description

On most currently known networks individual end users or end devices keep track of local storage allocation, determine what files are needed from the network for local use, what files are to be shared or private, what data to retain, and how long to retain. These decisions are typically made solely based on the needs of the individual device that are dictated by the behavior and prioritization of the end user. The hardware devices contemplated for use as peer nodes in accordance with the present invention may be configured to automate all of these processes, and configured to base all of these decisions on the global state of the network in order to optimize the state of the entire network when possible. So while the data management decisions are made on a local level, it is based on global information, and the resulting decisions are shared globally.

In other words, when data is not being transferred on the network between nodes, the data stored at each node stays put within allocated hard disk space. When data is transferred either through the push mechanism (when it is disaggregated) or through the pull mechanism (when it is aggregated), then old data is deleted at the receiving end of the transfer to make room for new data.

The Data Management Mechanism of the present invention determines which data is to be deleted and which data is to remain whenever an action occurs.

If for whatever reason data is overwritten or is no longer available on the network (for example, because a peer has been disconnected) and that copy of that data was needed to maintain the minimum scarcity level required by the Global Database for a given file/piece of content, then either the processes running the Global Database or the individual peers that have duplicates of that data when referencing the Global Database will trigger the Push Mechanism to propagate the data so that it is above the minimum scarcity level mandated by the Global Database.

Process Description

Data Management values and “Triggering the Push Mechanism”

1. As peers update the global connection database during the pull and push operations, the Global Database will know how many peers have each file/piece.

2. For each type of data, the Global Database maintains a value for the minimum number of copies acceptable on the network. This minimum number is known as the “scarcity floor.”

2.1. The scarcity floor is set by an operation that compares the success rate of files to their scarcity floor.

2.2. Success rate would be the inverse of the failure rate, with failure being measured as an instance where a downloading peer cannot find an adequate selection of peers with a given data fragment to maintain the data rate necessary to carry out real time data transmission.

2.3. Failures of this sort would be reported by peers when they go back to the Global Database for the most updated list of the peers on the network that have the necessary data fragments. Along with the request for additional peers, the peer making the request would note that it was in a failed state or near failed state such that data playback or video decoding was forced to stop, or such that buffer had become less than adequate and there were no additional peers supporting the data transfer. This notification of failure would be associated in the Global Database with the given media file and the aggregate of these reported failures would be associated with the properties of that media file such that a separate set of algorithms could weigh the failure rate against specific variables such as media bit rate, age of the file, the popularity of the file, etc.

2.3.1. As a protection against inaccurate reporting, peers would not report errors through this channel if they are able to determine that the failure was caused by anything other than a lack of available peers to connect to. If the failure occurred because of a problem with the ISP or in home routing hardware for example, the peer would not report that to the global database but would instead count it against its own record of uptime and reliability.

2.4. If the failure rate of a given media file or broadly, a type of media file or media files sharing specific characteristics display higher than acceptable failure rates, the minimum scarcity floor will increase at the global database. The performance with this new increased scarcity floor will be monitored and compared to the previous configuration. If it fails to make a big enough difference it may be increased again or if it degrades performance in any way it may be decreased, etc.

3. When a fragment of a file is initially received by the receiving node in a push or pull transfer, it is given an initial numerical value. This value is representative of how important the data is to the network as a whole as well as the local device. Some but not all of the factors are as follows.

3.1. Type of Data: streaming or not streaming

3.2. Bit Rate: higher bit rates may require more redundancy and thus will have a higher value.

3.3. Media Tags: some media types are more ephemeral, while others are more likely to have spikes in demand (i.e., local TV news versus latest episode of a primetime drama) media types that are likely to have low demand will have a lower initial value.

3.4. Local Affinity: each device will have awareness of the likelihood of its end user to request given data based on media tags, thus relevant data is preferred at each node and given a higher value pre-caching—for example if someone is watching a TV show that is two years old and still on the air and they watch episodes 1, 2 and 3, it is a safe bet to start downloading episodes 4, 5, 6, etc. If the push mechanism or some pre-caching mechanism utilizing the pull mechanism has done this, then both the initial value should be very high and the decay rate should be very slow based on the assumption that episodes 4, 5, 6 will be watched. The local device will have the algorithm to assess that if someone watches episodes 1, 2 and 3, the likelihood that they will watch episode 4 is X that they will watch episode 5 is Y, etc. and if they do watch episode 4, the likelihood that they will watch episode 5 will increase to 2Y or whatever is correct for that scenario. These prediction algorithms would be developed over time based on the user behavior and network performance, but the “local affinity” value that would be set by these and other algorithms would be very important factors in determining the importance of data retention for a media file.

3.5. Scarcity: the more scarce a file is the higher its initial value.

3.6. Pre-caching status: whether the data is being pre-cached for an anticipated flash crowd or not.

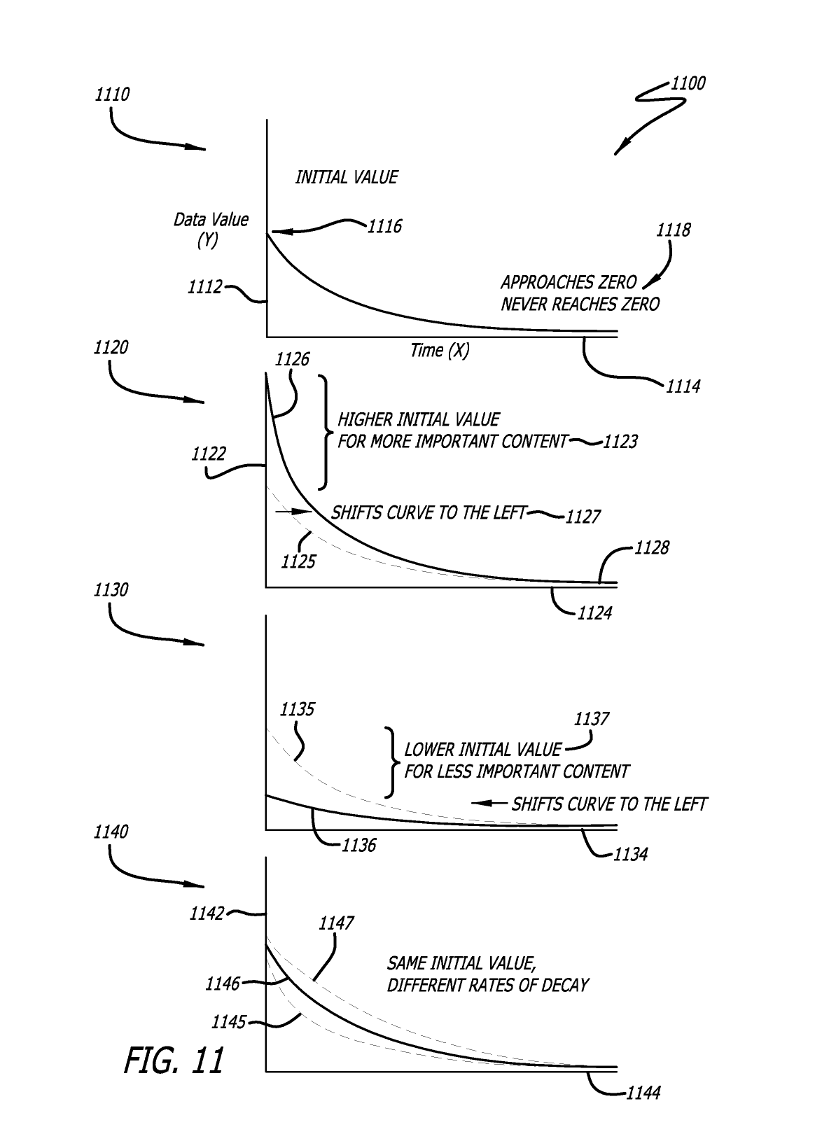

4. Starting immediately after the file is initially received and its initial value is set, the value of that file 1112 decays at a given rate whereby over a given interval of time 1114 the value decreases fractionally, always approaching zero but never reaching it (see FIG. 11). The rate of this decay is set by a variable in the Global Database that each peer references periodically to maintain an up-to-date local data set.

Referring further to FIG. 11, when data is initially downloaded to a peer either through the Push Mechanism or the Pull Mechanism 1110, 1120, 1130, 1140, the data is given an initial value 1116, 1126, 1136, 1146 and from that point it decays exponentially such that it approaches but never reaches zero 1118. Different content and different types of data will get a different initial value, and this will vary from peer to peer based on that peer's local affinity and user behavior as well as the network traffic patterns it attracts based on its characteristics. In addition to having different initial values for different scenarios, the rate of decay may vary across similar variables.

5. Each time an individual data fragment is accessed for a push or pull transfer, or for local playback on the local device, the value is given a boost based on the type of action and determined by an adjustable algorithm that can reference the Global Database, and local database.

### Example

5.1. If a file is needed by many other peers, then it is worth keeping;

5.2. If a file is being watched currently, then it is necessary to keep;

5.3. If a file associated with that file is being currently watched, then it is necessary to keep;

5.4. If a file has a scarcity issue, then it needs to be kept;

5.5. If a file is being pushed or needs to be pushed, then it needs to be kept; and

5.6. If a file has just been pushed because it had a scarcity issue, then it needs to be kept.

6. Over time, all of the fragments on a device approach zero, but the most accessed, most relevant, and most scarce data will always have the highest value at any given time.

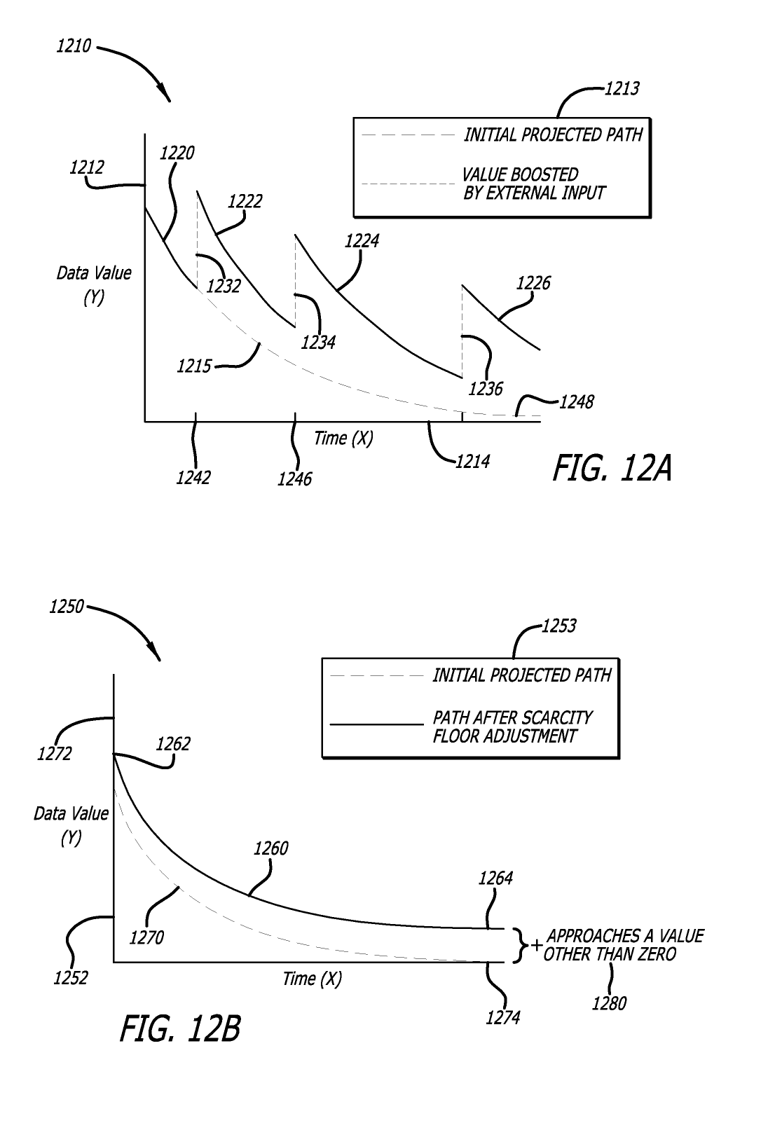

7. If ever a file falls below the minimum scarcity level, then the value 1212, 1262, 1272 of that file will be fixed such that it approaches a number other than zero 1280 that correlates to its relative priority level based on scarcity and demand (see FIGS. 12A and 12B). In this scenario 1210, 1250, random external events 1232, 1234, 1236 boost the value of the data 1212 such that the decay rate 1260, 1270 remains the same, but the value over time 1242, 1246, 1248 does not actually decay at a constant rate over time 1214, 1274. If data on the network becomes too scarce, the data management value of that data at each peer gets a boost such that the decay approaches a number 1264 other than zero, guaranteeing that it will not be overwritten until all other data is overwritten, or until its scarcity floor requirement is met.

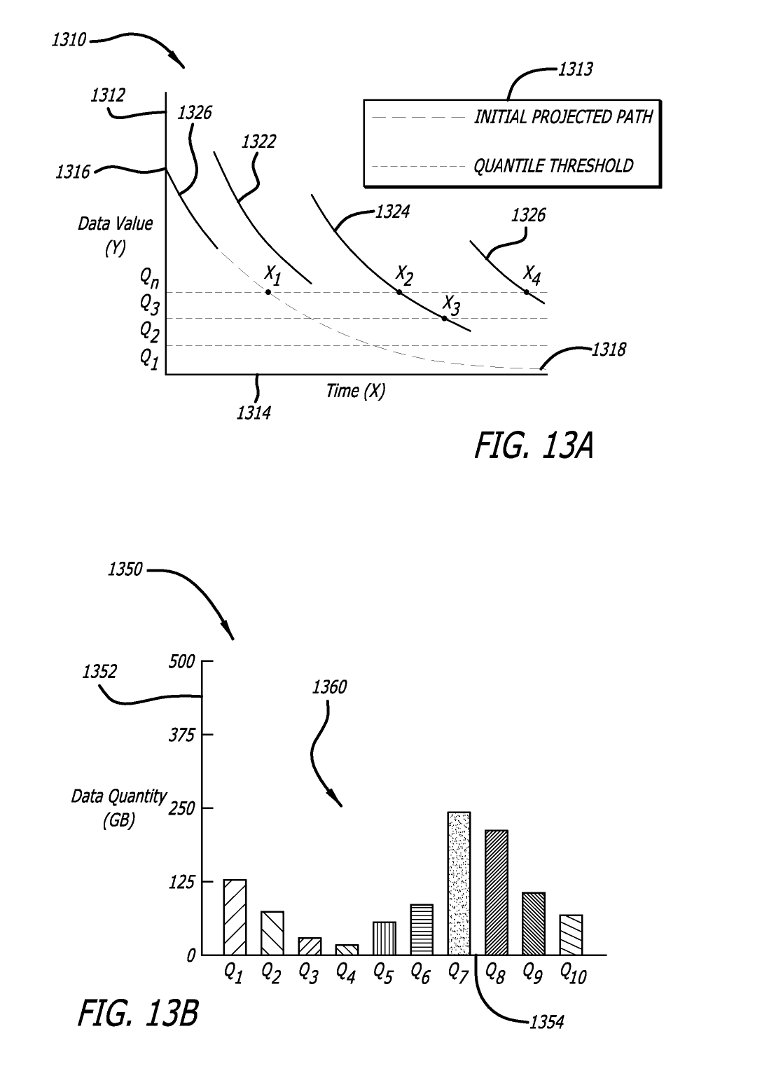

8. When each node shares its information with the global database about the data it is storing, the fragments are grouped based on their data management values such that other subsequent processes are able to compare the data management values of one peer to that of another (see FIGS. 13A and 13B). The data management value 1312 of a given piece of data varies over time 1314. The global database sets an algorithm for each peer to categorize each piece of data at any point in time 1316.

Referring further to FIG. 13A, the horizontal lines Q1 Q2 and Q3 represent cutoff points for categorizing the data into quantiles set by the global database. At the time X1 the projected path of the data 1326 would have entered Q3; however, after receiving multiple boosts by external inputs 1322, the path 1324 enters Q3 at X2 and enters Q2 at X3 before leaving Q2 and jumping above Q3. The path 1326 re-enters Q3 at X4, and would continue eventually ending up in Q1 if not adjusted by another external boost.

Referring further to FIG. 13B, at any given point in time 1354, each piece of the data stored on a local device will have a current data management value. All of the data will be grouped into quantiles based on these data management values and the sum total of the storage capacity used by the data in each quantile will be reported to the global database to be associated with the individual peer ID and used for peer selection by the Push Mechanism. In this example the peer has 125 gigabytes (GB) of Q1 storage, 70 GB of Q2 storage, 27 GB of Q3 storage and so on.

8.1. Essentially, the distribution of data management values across the stored data on a peer device at a given moment in time would resemble a curved graph of exponential decay. It would be easy to divide all the data points into quantiles. These quantiles would be divided at the interval set by an adjustable variable at the global database. The resulting information when processed would be sent to the global database where it would be kept on record that that individual peer had X data in Q1, Y amount of data in Q2, N amount of data in Qn and so on.

8.2. The information on the data management value distribution for each peer would be updated periodically at the global database as part of a background operation.

9. Data is never deleted without motivation; it is only marked to be overwritten by other new data when the new data becomes available.

10. When each node pulls new data, or when new data is pushed to the node, the locally stored data with the lowest value is the first to be overwritten by the new data.

The data management system is critical in attaining an automated and spontaneously ordered system. It makes sure that the most important data is treated as such while the least important data still maintains a minimum standard of redundancy.

III. Data Preparation Mechanism

Step 1—Where the Data Starts

Although the system itself operates to store data, deliver data, and measure the process to improve the efficiency of storing and delivering data in a closed loop environment, the usefulness as a content distribution network assumes that there is new data, aka content, being added to the network that needs to be stored and distributed. This data is created independent of the network and added to the network through the Push Mechanism.

Although it could functionally originate at any node on the network, in a practical application it would originate at a dedicated server or group of servers operated by the network managers. While these servers would act as any other node on the network to the extent of this patent, they would likely have more software and features enabling the network managers to have more secure and direct access for manually inputting data.

Step 2—Initial Meta Tag Structure

As data is created it forks into various types of data. This is based on ID tags or Meta Data that is associated with the data at creation. In addition to this initial static meta data, all data being stored and delivered on the network will also have dynamic meta data that changes over time and is used for prediction algorithms and to adjust data management priorities as well as things like adequate buffer in peer selection.

Static meta data would be:

(a) The name of the file;

(b) The type of file;

(c) Bitrate, codec, container format, muxing, etc.;

(d) The genre(s) and subgenre(s) of the content;

(e) One time live event;

(f) Daily news content;

(g) Serialized content; and

(h) Other relevant data or content.

Dynamic meta data would be:

(a) How it relates to other genres or types of content based on the users that watch it and when they watch it;

(b) Fail rates of data transfers;

(c) Re-run frequency;

(d) Sponsorship or advertising pairing;

(e) Pre-caching instructions; and

(f) Other relevant data or content.

Step 3—Special Multi Bit Rate Processing for Streaming Data

Streaming data is encoded into multiple files with different bit rates. These files are associated as the same piece of media through shared meta data and a common container format, however they are treated as distinct files for the purposes of Data Management, scarcity, fragmentation, and the Push Mechanism. That is to say that for a film or television show, the content of each file is the same audio and video at each point in the timeline, but the quality and resolution of the audio and video varies from file to file.

During the Pull Mechanism, the pulling peer measures its performance and makes decisions about which file to pull fragments from. Any combination or mixture of the files along a timeline will render the entire film or television show, as long as the data fragments correlate to a completed timeline (see FIG. 4).

How many iterations and which bit rates are determined by referencing the meta-tags to an instruction database. That is to say that for example, file A is encoded with eight mbps, six mbps, four mbps, two mbps, and one mbps, where file B is encoded with eight mbps, four mbps, and one mbps. As peers pull files A and B at different times across the network, those peers will record statistics about the performance of the download and video playback, specifically, how much buffering was required, what was the distribution of priority levels during the transfer (high, normal, low), how much data was wasted through data not being delivered on time, and what was the average total throughput of the transfer. That data is shared with the Global Database, which compares results and determines what the instructions should be for future encoding standards. If the time taken to switch between eight mbps to six mbps to four mbps to two mbps significantly lowers the average video quality (total throughput/data rate of a transfer) or increases buffering requirements in comparison to switching from eight mbps to four mbps, then future encodes may be set to mimic file B rather than file A. Likewise, if files set at eight mbps very often have to jump down to 6 mbps or four mbps, but files set at seven mbps often can stay at seven mbps without jumping down, then a new standard of seven mbps video might actually yield higher average data rates, and so forth.

Step 4—Hashing

A hash table is created to reference each data file, static or streaming, as a set of fragments. Just like the variable bit rate encoding scheme, the size of the fragments/pieces can vary and the standard settings for new files can be improved over time by the global database.

For example, if a network has a lot of dropped connections, large file sizes are inefficient because a lost connection will result in losing larger pieces of data while if the network is very stable, switching between smaller pieces more frequently will be heavily affected by latency and will slow the download, etc. As peers use the pull mechanism to transfer data and those peers log the statistics regarding their transfer speeds the global database will take the results into account to determine what piece sizes should be used for future hashing.

As with encoding, if previously hashed and encoded files fall too far outside the threshold of performance based on bad piece size or encoding settings, the file can be automatically re-encoded or re-hashed and pushed into the network to replace the previous version. This threshold can also be adjusted based on how adversely such re-hashing or re-encoding and re-pushing affects the overall stability and performance of the network versus the benefit to that file's performance over time. Also, this threshold mechanism can be designed to wait to trigger changes until off-peak hours for traffic on the network so that it does not contribute to any bottlenecks.

### Summary

The Data Preparation Mechanism is the step in the feedback loop that takes data from previous configurations and creates new optimized configurations for new data.

IV. Push Mechanism

The Push Mechanism is responsible for disaggregating content across the private network. This section will go into detail on how the data is fragmented and where those fragments are spread across the network.

Basic Description of the Push Mechanism

The Push Mechanism is both the process by which new data/content is added to the network by an administrator (or potentially user generated content) as well as the process by which the Data Management Mechanism preserves minimum levels of data redundancy on the network.

To be noted, the Push Mechanism is not exclusive to propagating new ‘content’, but rather, it applies to all new data, even including analytics information that is generated and propagated continuously or information shared by users in a social networking or communication application.

How Data Spreads Across the Network

1. Announce—The hash table and metadata are sent out to the global connection database which functions as a clearing house for information between the various processes and the different nodes on the network.

2. Multiple Bit Rates—When disaggregating streaming content, the Push Mechanism treats each encoded bit rate as a distinct media file to disaggregate and each distinct bit rate has its own scarcity floor requirement based on the bit rate and other variables.

3. Local Affinity/Pre-Caching—If there are any requests for that data based on the meta tags sent to the global connection database, the data is sent there first.

3.1. For example, peers that are downloading a TV series will be likely to watch the next episode as soon as it is available and a pre-caching algorithm at a local peer would set an affinity level for that anticipated future content that would put it on the list with the global database of peers that are interested in the new content as soon as it becomes available. Another good example would be ongoing programs like daily/nightly news shows.

3.2. Of the peers with requests for the content, the data of each distinct bit rate is sent to peers whose average upload throughput exceeds the given bit rate multiplied by an asymmetry factor.

3.2.1. The average upload throughput is part of the shared data associated with each peer ID at the global database and in the local databases of peers with connection histories with a given peer.

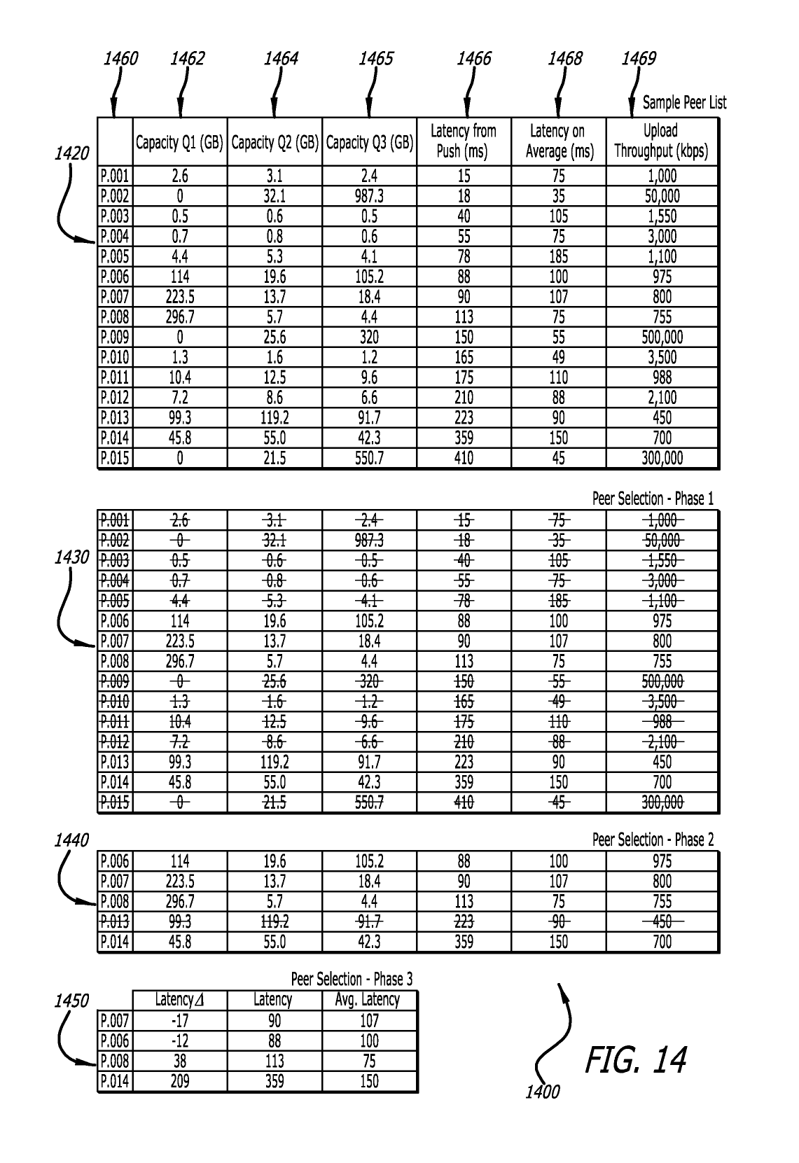

3.2.2. The asymmetry factor is a fractional multiple that represents the average asymmetry in upload to used download bandwidth across the network. In the US market this would be something like one upload to five downloads, but in practice would be a result of measuring peer capacity across the network. Assuming a 1:5 upload to download ratio, this would mean that if the data rate of the data being pushed were 4 mbps, it would seek peers that had an average upload in excess of four mbps X 0.2 that is to say 0.8 mbps or higher. See FIG. 14 and see ADDITIONAL NOTES—Alternative Asymmetry Factor for the Push.

3.2.3. That asymmetry factor is adjustable based on performance like all other variables and is stored and updated at the Global Database.

3.3. If the data is requested and sent to enough nodes to satisfy the minimum scarcity requirements of the data management mechanism for each bit rate version, the push is complete.

4. Overwrite Lowest Priority Data—If there are not enough peers with request for the data to satisfy the minimum scarcity requirements for each bit rate version, the origin looks for peers that have the best available storage.

As described herein regarding the Data Management Mechanism, the global connection database has data management reports from each peer that indicate based on quantile slices how much low priority data each peer has (see FIG. 13B).

If the initial push requirements to satisfy minimum scarcity are not met by local affinity requests, the push selects peers based on their ability overwrite the least important data on the network by selecting the peers first that have the largest amount of the lowest priority data set by the data management mechanism (see FIG. 14.).

5. Peer Selection—Once it has found those peers with the appropriate storage capacity, in a simple implementation it would select the peers with the largest quantile of the lowest priority data but in a more complex implementation it would use a threshold mechanism to narrow the group similar to how the low priority mode peer selection filters for low popularity where if the narrowing threshold produces to small of a subset to make a second layer selection algorithm worthwhile, it will relax the threshold to include a larger subset. With the optimal subset of target peers, the pushing node will conduct a handshake with the potential target peers to find out three key variables:

5.1. Is the peer busy? If so it will not be pushed to.

5.2. What is the average latency of the peer to other peers?

5.3. What is the current or established latency between the pushing peer and the target peer?

5.4. The pushing peer will then select the peers that are not busy and that have the largest variance in latency to the seeding peer but whose average latency to other peers is less.

This is referred to as the Latency Delta (D). For example, if the seeding peer and the target peer have a latency of three-hundred ms and the average latency for the target peer to other peers is three-hundred-twenty ms, then that peer would not be prioritized because on average it is not a low latency peer. If however, it had an average latency to other peers of one-hundred ms, it would be acceptable because it is far away from the pushing peer but closer to other peers.

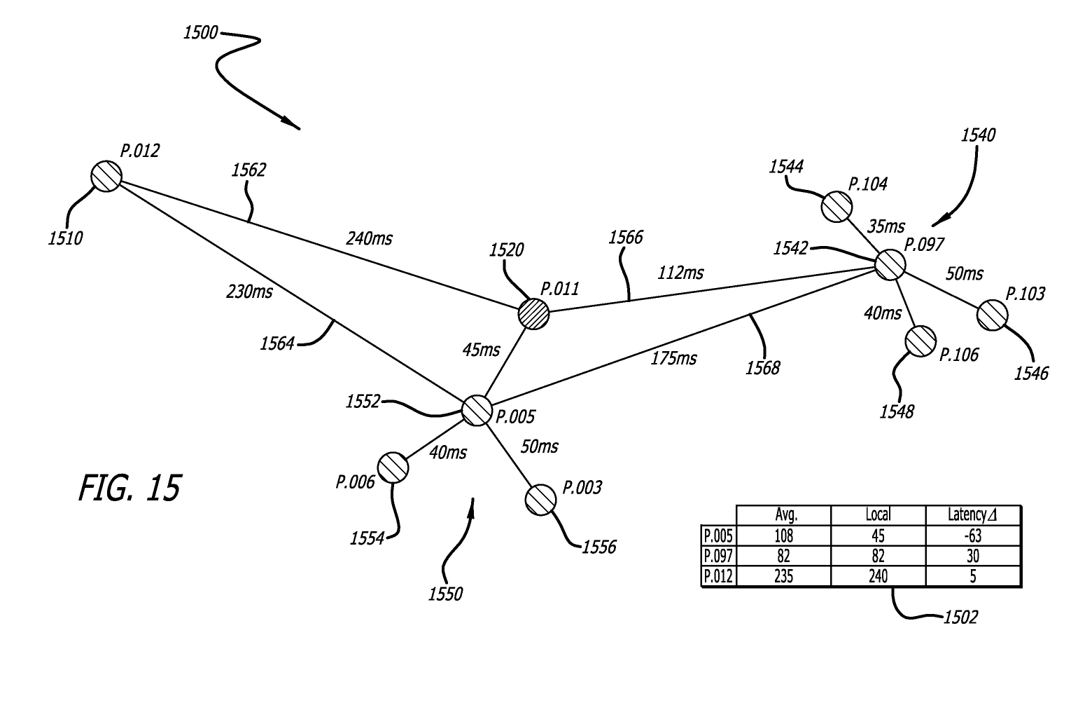

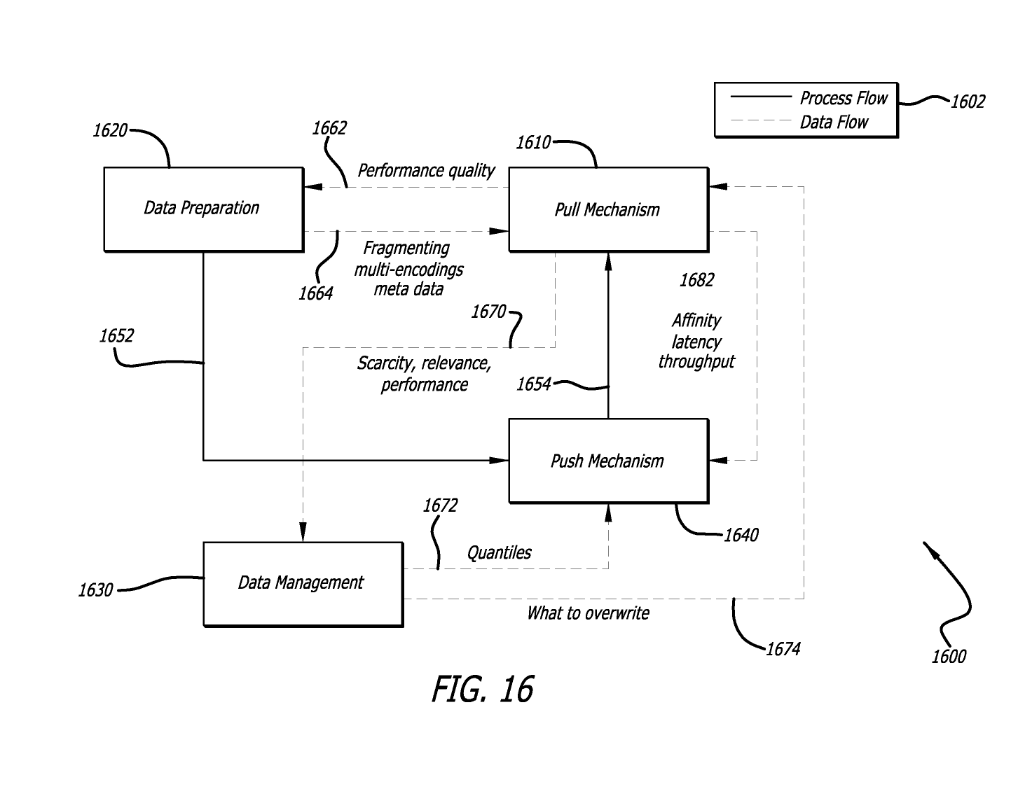

The goal of this algorithm is to ensure that the data is distributed by the Push Mechanism as evenly as possible across the network without creating excessive overhead (see FIG. 15).

Referring further to FIG. 14, “Peer Selection” 1400 works in the Push Mechanism similar to that shown in FIGS. 7-9. For example, the “Sample Peer List” spreadsheet 1420 represents data wherein each peer 1460 has a recorded Capacity in gigabytes (GB) for Q1 (1462), Q2 (1464), and Q3 (1465), and the list would go on to include all other quantiles. This is the same data set as in FIG. 13B, where the global database receives totals from each peer for data capacity in each quantile. Each peer tracks its latency 1466 on average to all other peers listed as “Latency on Average” 1468. This latency value is compared to the locally recorded latency 1466 from the peer carrying out the Push Mechanism to the candidate peer.

In “Peer Selection—Phase 1” 1430, the uploading peer first seeks other peers 1460 with adequate Capacity in Q1 (1462). This example assumes eighteen GB of storage is required. If there were no peers with eighteen GB of Capacity in Q1, then the uploading peer would select other peers with a total of eighteen GB by combining Q1 and Q2 (1464). If no adequate capacity was found in either Q1 or Q2, then the peer would be chosen from the combination of the three quantiles and so on. In “Peer Selection—Phase 2” 1440, the uploading peer eliminates the remaining peers that do not have adequate upload capacity. The minimum upload throughput 1469 is the data rate of the media (this example assumes 3500 kbps) multiplied by the asymmetry factor, which in this example assumes 0.2 resulting in a minimum throughput of seven-hundred kilobytes-per-second (kbps). In “Peer Selection—Phase 3” 1450, the farthest away of the remaining peers is selected. This is done by finding the difference between the Latency from Push and Average Latency which is referred to as the Latency Delta or Latency A. Of these peers it chooses the peer with the highest Latency A. Accordingly, peer P.014 is selected in this example.

Referring further to FIG. 15, in the algorithm of the present invention to use latency data 1502 to spread network traffic, the densely shaded central circle 1520 is the uploading peer carrying out the Push Mechanism 1500. The outlying circles 1510, 1542, 1544, 1546, 1548, 1554, 1556 are the candidate peers for the Push Mechanism. The lines 1562, 1564, 1566, 1568 represent the connections and are labeled with the latency of those connections in milliseconds (ms). The Push Mechanism of the present invention may be configured to evenly spread the data across the network. If the peer selection algorithm simply picked the peer with the lowest latency, the uploading peer would select P.005 (1552). If that were the case, then the data would move closer to P.003 (1556) and P.006 (1554), but would still be just as close to the origin P.011 (1520). If the peer selection simply picked the peer with the highest latency, it would select P.012 (1510). If that were the case, then the data would move further away from P.011 than if it went to any other peer; however, the data would not be spread closer to other relevant peers 1540, 1550. The optimal choice is P.097 (1542), because it is both farther away from the origin than P.005 and closer to relevant peers than P.012, meaning that the data is now more evenly spread in relation to all other points on the network than it would have been otherwise. To select P.097, each peer averages its latency to each other peer it is connected to and that is subtracted from the latency to the origin P.011 to give the Latency A (1502). The peer with the highest Latency A will be the peer that is both far away from the origin but on average closer to other peers.

6. Fragmentation—The data can be transferred in whole to individual peers, but does not necessarily need to be transferred in whole. The hash table and meta tags are dynamically shared with other peers to identify the location of the fragments so that they can be reassembled from multiple sources, never requiring a “complete file” to exist at any one node on the network for any other node to be able to assemble one on demand. In some cases, it may not be ideal to push only a small fragment of each media file to a large set of peers when compared to pushing complete media files, because it would require the future peers pulling the data from many different peers and conducting many different peer selections rather than making optimal connections early on and being able to maintain those connections through a complete media file. See “ADDITIONAL NOTES—Predictive Peer Selection Through a Smart Piece Picker” herein. Over time, the data will automatically become more fragmented as peers pull only pieces of a media file or through other operations.

Final Step—If all of the steps above are carried out and the data is still not achieving its scarcity floor, fragments will be pushed to overwrite data on the network in the next quantile of data management priority level. If this problem persists the rate of decay in the data management mechanism will be automatically adjusted to decay unimportant data more quickly.

Additional Notes

Piece Picker Algorithm

The sequential aspect of the download is not the order in which the downloads complete, but is the order in which the pieces are picked by the pull mechanism. In a sequence 1 through 5, piece 5 will only be selected for download if pieces 1-4 have either already been completed or are already being downloaded.

There may be a possible exception to this particular mechanism, however, if it is decided that the download has proceeded well enough, that is to say a second safety threshold has been surpassed, then the Pull Mechanism may download key frames and clips from non-sequential sections of the media to allow for smoother chapter skipping or fast forwarding.

In addition to downloading multiple fragments simultaneously, as shown in FIG. 3, each from different peers, the Pull Mechanism may also download the same fragment from multiple peers simultaneously to minimize the possibility that the fragment will not be completed in time for playback. A good example of this would be in FIG. 10, if the file transfer with P2 (1020) completes and P3 (1030) has completed, but the transfer of P1 (1010) fails, when the download is in high priority mode 1084, the pull may use P2 and P3 or additional peers to simultaneously attempt to download the missing fragment to fill in the gap between the completed pieces 1052, 1054 before the playback is interrupted. As soon as any one of those transfers completes the download of the missing fragment, the Pull could move on in normal mode ahead of the downloaded section 1080.

Referring further to FIG. 10, which is based on the diagram in FIG. 3, the buffer is calculated for each priority mode of the Peer Selection algorithm. In accordance with the present invention and by way of example, different pieces of data may be being assembled from four (or more) peers labeled P1 (1010), P2 (1020), P3 (1030), and P4 (1040). As shown in FIG. 3, example pieces of the file are being downloaded simultaneously from multiple sources, and assembled just in time for playback. As shown in FIG. 10, the download 1054 from peer P3 has finished and is placed in the timeline 1050. This exemplifies the fact that while the pieces of the file are assembled sequentially and selected to be downloaded sequentially, the actual downloads may finish out of sequence. In this case, the “current buffer” 1084 is measured as the length of time between the “playback location” 1075 and the end of the “downloaded section”1080. This example is a snapshot of a timeline and, at this particular moment in time, the “current buffer” is larger than the “minimum buffer” 1082 and less than the “safety threshold” 1086 so this download is in normal priority mode 1090.

In FIG. 10, if the download from peer P1 (1010) did not finish by the time the “playback location” 1075 moved one or two squares to the right 1052, 1054, then the “current buffer” 1084 would be less than the “minimum buffer”1082 and the download would be in high priority mode 1094. Conversely, if the download from P1, P2 (1020), and P4 (1040) finished before the playback moved one or two squares to the right, and additional pieces were also downloaded from either a yet to be seen peer Pn or again from the same set of peers P1-P4, then the “current buffer” would have expanded past the “safety threshold” 1086 and the download would be in low priority mode 1092.

Manual Override—if the user chooses of course they can download in non realtime bit rates/sets of pieces that exceed their download capacity at which point they have to wait for the file to download.

Pull Mechanism Priority Level Through Piece Picker

As an alternative to using buffer thresholds to determine the priority level of a transfer for peer selection, the priority level could be pictured in an implementation where it was determined per piece rather than as it is otherwise implied, for the entire transfer. In this regard, the peer selection mechanism per piece could be different where the peer picker ranks pieces by some order related to their proximity to the playback location and based on those proximity rankings, some pieces may be in high priority peer selection mode while others may be in normal or low priority mode, even during the same pull operation. This is to say that the buffer calculations that would apply a priority mode to an entire transfer could be calculated for each piece by the piece picker process. Essentially, it is easy to picture the peer selection mechanism as a process applied to each piece rather than to a whole file and the piece picker process as the process that aggregates the file for playback.

Data Management Per Fragment

Depending on the size of fragments, the data management mechanism may track individual fragments for their data management value, assigning more value to fragments of more watched or more relevant sections of each piece of media. This would work, for example, if there was a car chase sequence in a film that many people wanted to watch over and over again. It would be more likely that that clip would have a higher data management value than the other parts of the film. The beginning of a film or TV show may be another example where many people will start watching the show but stop watching part way through. This would add traffic to those fragments but not to the entire TV show so in this situation having the data management mechanism track per fragment rather than per file would make perfect sense. If the database overhead of tracking so many small fragments outweighed the benefits, however, this may not be done in practice. It is very likely though that with larger file fragments this would be no problem at all.

Alternative Shared Data Techniques and Peer Recommendations

You could envision a system where peers collect data about unknown peers based on shared data given to them from other peers, that is to say that peer A may keep a record of its relations with peers AB and AC. In a communication with peer B, it may be motivated by the design of the system to share with peer B the fact that peer AB is an excellent peer to use and peer AC is a horrible peer to use. This could be accurate if over time peer A and B know that they have similar results when connecting to the same peers, Accordingly, peer B could know with a measurable certainty that it would be better to connect to peer AB than AC without ever having connected to either. As described, the value of that recommendation can be measured ranging from, “this is 100% reliable” to “take it with a grain of salt.” Also the recommendation could be more granular than a simple “this is excellent” to “this is horrible.”

Alternative Distributed Architecture

The main system design often references the global database and it is footnoted that this database could be a distributed database or a centralized database or a combination of the two. To further expand on this concept, a handshake based system along with a DHT style tracker system would allow for many of the system design elements to function in a completely serverless environment. For example, during a pull operation, instead of first sending a request for the location of desired data to a central database server and receiving a list of peers with that data, the pulling peer could send out requests to several known peers on the network similar to how Gnutella functions. In this scenario some search queries would not find the peer they were intended for due to dynamic IP addresses on the network, of those that were found, they may or may not know where that particular file is, but unlike in the Gnutella design, where each peer is for the most part only aware of the files it indexes, the system could be designed so that each peer indexed far more files than it would on a normal file sharing application, making the distributed search function less cumbersome.

For example, as the pulling peer connected to the peers known to have the data of interest, those peers would be able to provide the identification of other peers on the network that it either received the data from in the past or that it had since uploaded the data to, essentially keeping a trail of breadcrumbs for each file on the network and generating fairly direct paths to finding peers. In this scenario, the peer selection process would still be able to function the same way, using a database of known peers to make a decision based on performance history and based on the priority status of the download process.

The Data Management Mechanism would function slightly differently as the global variables such as the initial value of different media types or the minimum scarcity levels for certain files would be more difficult to measure. This process would probably be carried out through subsampling, by having various peers capture the shared data of known peers at a given moment in time, processing that data into averages and then comparing that data to find a more representative and larger sample. Having a good sample of the network, those peers could then make calculations in the same way that a central server could, and those calculations could set new variables for the “Global Database” about minimum scarcity requirements or initial data values for different media types. Rather than being stored in one place, however, those peers would push those newly calculated variables to other peers that would overwrite the old version of those variables with the newer ones through synchronization that would occur either as a background operation running at an interval or by as a part of other shared data exchanges. Although if poorly designed, this system may not be as reliable as the centralized version, if well design with proper symmetry and data synchronization, it could be even more stable than alternatives because of built in redundancy and error checking.

The other important difference with the Data Management Mechanism is its effect on the Push Mechanism in an alternative distributed database architecture. The Push Mechanism typically would receive the data management breakdown (as shown in FIGS. 13A, 13B) from the central database server about each peer after those peers have reported that data to the central global database. In the distributed model, however, the data management breakdown for each peer is not known to the Push Mechanism without first sampling peers to find out those values. Unlike in a pull mechanism where a limited set of peers serve as a target for the pull based on the condition that they are storing the necessary data, the Push Mechanism does not have a narrowed scope and all peers are potential targets though some better than others. It may though have to narrow its scope to peers in its local connection database because it cannot retrieve the location and identification of peers beyond those it already knows without recommendations from other peers. Of the peers that it knows, it could simply query them for their up to date data management breakdowns and carry out the push based on those values. The same is true for the affinity based pre-caching option in the Push Mechanism, where it could send out an announcement that the new data was available or that scarce data needed to be pushed, and the receiving peers could reply with a message stating their interest. This method would be the alternative to having those messages already stored in a global database prior to such an announcement.

Note on Granularity of Global Database for Fragment Locations

In the previously described implementation, the Global Database tracks the locations of fragments as they move from peer to peer. This information is either updated as part of a granular data management report describing every piece available, or as a function of the pull mechanism reporting it as part of shared data, or a separate communication processed periodically to update the Global Database with a list from each peer as to the fragments it is storing.

While it is possible for the Global Database to maintain a fairly up to date list of the locations of all fragments, it is much more likely that the overhead to do so would out weigh the benefits of such a method and as an alternative the data on record with the Global Database can be more selective and less detailed, while still achieving similar objectives.

To account for different use cases, it may be ideal for the “list of possible peers storing the necessary data fragments” or the “torrent like file” received by the peer from the global database when initiating a Pull Operation to categorize those locations based on tags that indicate which peers have only “partial copies”, which peers have “completed copies”, and which peers have “completed copies of the first portion of the file.” The overhead of tracking this data is far less but achieves many of the same goals. The more granular information about exactly which pieces of each file at each bit rate each peer has at the time of a prospective pull operation can be something that is shared between peers after they have connected.

When a peer initially connects to other peers, it will be in high priority mode because it will not have any of the data needed to create even a small buffer and perhaps in such a mode it should only connect to peers that have the entire file or peers that it has already connected to enough to know that that peer will have the pieces it needs before it sends the request for those pieces and wastes precious time. In this scenario it would be equally as good to connect to a peer that had, for example, the completed first 5 minutes of a 30 minute TV show, as it would be to connect to a peer that had a complete copy of the file because it is only important that the first part be complete during the first part of the download. For this reason tracking the “size of the completed segment from the start of the file” may be the best way to log that information, this way a peer can apply a threshold to that tag to decide if in fact based on its performance logs, a complete first segment of X size is equally as good as a “completed copy” of the entire file, for the initial connections.

Predictive Peer Selection Through a Smart Piece Picker

In writing software for dedicated hardware, the concept of a light program is less important. One higher overhead feature that could be a benefit is predictive peer selection based on a future aware piece picker.

In a normal scenario, a given peer would not necessarily contain a version of a media file where all of the fragments in sequence were the same bit rate from beginning to end. It would be more likely that those fragments were retrieved during a pull operation and that that operation was carried out at several different bit rates.

Having connected to peers during a pull operation, the pulling peer would have a map of the fragments stored by each peer and could analyze the maps of different peers to determine the path of least resistance when making its peer selection. For example, if a data transfer is currently being carried out at Bit Rate “1”, then Peer “A” has a mixture of bit rate 1 and bit rate 2. Peer B has the entire file in bit rate “1”. Peer A will only be useful during the section of the timeline that it is storing bit rate 1. Using Predictive Peer Selection, the pulling peer could use Peer A for those fragments and Peer B for the fragments that it cannot get from Peer A in such a way that it downloads from both peers continuously. If however the pulling peer did not factor this into its peer selection, it would download every other fragment from Peer A and Peer B and upon reaching the section that Peer A only had Bit Rate 2, it would only be able to download from Peer B and no longer have the use of Peer A's upload. Because of the asymmetry of upload to download bandwidth on the market, it is very likely that all downloads will be comprised of connections with many different peers downloading many different fragments simultaneously.

Alternative Asymmetry Factor for the Push

A more precise way of calculating such a threshold for upload throughput would be to calculate the anticipated number of simultaneous peers the average pulling peer would connect to and divide the bit rate by that number to come up with the correct threshold.

In practical terms, the average minimum number would be downloading bit rate divided by the average upload throughput per peer.

The example used in the initial iteration of the asymmetry factor gives a 1:5 ratio of upload to download bandwidth across the network, which does mean that on average each download must at least connect to five simultaneous peers to reach its maximum download speed. This is not very precise and can be improved on.

One improvement would be that although the network may have a 1:5 download to upload ratio, this is disproportionate to the necessary download speed since some download speeds of twenty to fifty mbps would not need to be fully utilized, so the better limit might be the average upload throughput compared to the average download bit rate necessary. So for a four mbps download, if the average number of simultaneous connections is five, then the limit is 0.8 mbps. While that generates the same results, it should be known that peers on the network would optimize at a number other than the absolute minimum for connections per download so if the average number of simultaneous connections is twenty, then the limit is two hundred kbps, perhaps a more realistic and accurate result if the “average number of simultaneous connections per download” were measured and updated to the push mechanism's decision making process.

This process of filtering the push by comparing upload throughput to download bit rate per file does not have to be one hundred percent precise or accurate, but the intention is to steer lower bit rate files to lower throughput peers and higher bit rate files to higher throughput peers.

Bandwidth Self Throttling

There are various methods to determine the total upload and download throughput available to a peer by an ISP. This could be done by distinct speed tests, or a measure of downloads and uploads without limitations or restrictions.

Either way, the total throughput of a peer, once known can help determine self imposed download and upload speed limits such that it allows for a predetermined minimum remaining throughput for other activity on the device's local network. That is to say that a home user with a device in accordance with the present invention will not have one hundred percent of the home internet capacity used by the device, but rather that the device will limit itself to fifty percent or eighty or “all but one mbps” or some other measurable amount.

In addition to simple standard limits, a design that may also be implemented would include the ability to exceed those limits for “emergencies” that would prevent playback interruption or unwanted buffering.

The same manner of measuring and limiting may be also applied to the quantities of inbound and outbound connections such that the local network modem or router may have performance limitations below that of the default limits set by the Pull Mechanism and node may adjust those limits based on the performance of its local connection.

Tracking Peak vs Normal Traffic Hours

The capacity of each node on the network will be determined by a number of factors, but for the most part they will be limited by their respective Internet Service Provider (ISP) and the routing and modem hardware within the home network. From the ISP perspective those effects will be the limitations either artificially set by the ISP or physically a limitation of the network. During non-peak traffic, it can be assumed that the throughput of a peer will be limited to the artificial limits of the Internet connection but during peak traffic hours it is also possible for the overall network of the ISP to be under such strain that the performance is even more limited than intended by the ISP. That is to say that global traffic problems in one ISP network may affect the performance of individual nodes and that those affects are likely to be time sensitive to peaks in traffic. Because the system of the present invention may measure at many points on a network, it may be possible to determine whether a given ISP network is overloaded due to peak traffic hours and take that into account when measuring the performance of individual nodes such that in the connection records the performance of nodes may be weighed against the time of day for that network and its historic peak traffic times. Measurement systems can be implemented in the network to track and understand peak traffic times in order for the network to better prepare for peak while performing efficiently for non-peak hours.

Notes on Mobile Devices and Leachers

Although the initial iteration describes a system comprising of television set top boxes, it is possible for the same architecture to accept Pull operations from so called “leeching devices,” that is to say, devices without a greater capacity to upload back into the network. In this scenario, the data management scarcity measurements would not include cached data on leeching devices such as cell phones, tablets, or other wireless devices with small caches and weak upload bandwidth. Additionally, the Push Mechanism would not see these nodes as potential targets for Pushing Content. The amount of traffic diverted to these devices, however, could be measured, and the performance could be measured such that the Data Preparation Mechanism optimizes the data at some level for these transfers. The Pull Mechanism run by these leeching devices could also mirror the peer selection and piece picker algorithms. The other full powered nodes on the network would also measure outbound connections to these peers as part of their popularity, but this measurement may be a separate metric due to differences in the throughput required by such devices or the manual prioritization by the network administrators.

Extra Benefits

The system of the present invention favors the entire network's stability and quality of service (QoS) over that of any individual user.

The system of the present invention measures variables uniquely important to its design and uses those tracked variables to make changes to globally shared variables to automatically improve performance against specific metrics.

The system of the present invention organizes, and tracks in realtime, the performance of a large scale peer-to-peer network in a significantly different way than previous sub-sampling or snapshot based research.

The design of the system of the present invention allows for scalable support server integration for a peer-to-peer network. When adding servers that have large storage capacity, very high throughput, very low latency, and very high uptime, those servers will automatically be selected more frequently by peers downloading data from the networks. This popularity will be systematically offset by the peer selection decision tree, where popular peers are avoided by default and used only when it is unavoidable. This does two things:

1. It automates server integration, meaning that the servers can run the same basic processes as all of the other nodes without requiring separate protocols such as FMS, http or rtsp. This makes it easier to add capacity to the network fluidly and organically while still creating a backstop/failsafe for when the peer network is otherwise overloaded.

2. Making them the last resort means that the servers will always be used as little as possible. The main costs in content deliver are server hardware, server maintenance, server utilities, and server bandwidth. When the data is transferred between two set top boxes/two non servers, the cost to the administrator of the network is essentially zero because it involves none of those expenses. The less the network relies on servers the cheaper the network is to run and it is feasible that with an efficiently managed network, it would be possible to handle full television services over this architecture without any servers participating in core data transfer processes.

While particular forms of the invention have been illustrated and described with regard to certain embodiments of content delivery networks, it will also be apparent to those skilled in the art that various modifications can be made without departing from the scope of the invention. More specifically, it should be clear that the present invention is not limited to any particular type of node devices. While certain aspects of the invention have been illustrated and described herein in terms of its use with specific content types, it will be apparent to those skilled in the art that the system can be used with many types of content not specifically discussed herein. Other modifications and improvements may be made without departing from the scope of the invention.

We claim:

1. A method of distributing content a in a peer-to-peer network of user nodes, comprising:
providing a peer-to-peer network configured for distributing content using the Internet and having a plurality of nodes configured to receive and send content, each node being configured to act altruistically for the best interest of the network as a whole.

2. The method of distributing content of claim 1, wherein providing the peer-to-peer network includes configuring each node to act by favoring the stability of the network over its own performance interests.

3. The method of distributing content of claim 1, further comprising providing video content for distribution using the peer-to-peer network and configuring at least one node to act by favoring the stability of the network over the performance interests of the at least one node.

4. The method of distributing content of claim 1, further comprising configuring at least one node to act by favoring the stability of the network rather than the direct self interest of the at least one node.

5. The method of distributing content of claim 1, further comprising configuring each node with a potential of being similarly altruistic in the decision making by each node.

6. The method of distributing content of claim 1, further comprising a pull mechanism, a data management mechanism, a data preparation mechanism and a push mechanism.

7. The method of distributing content of claim 6, wherein the pull mechanism is configured to provide each node the capability to process a request for data playback by an end user such that disaggregated data is aggregated just in time for playback.

8. The method of distributing content of claim 6, wherein the data management mechanism is configured for prioritizing information for deletion and, conversely, maintaining adequate redundancy by preventing deletion or triggering the Push Mechanism when applicable.

9. The method of distributing content of claim 6, wherein the data preparation mechanism is the step in the feedback loop that takes data from previous configurations and creates new optimized configurations for new data.

10. The method of distributing content of claim 6, wherein the push mechanism is configured is responsible for disaggregating content across a private network.

11. A system for distributing content a in a peer-to-peer network of user nodes, comprising:
a peer-to-peer network configured for distributing content using the Internet and having a plurality of nodes configured to receive and send content, each node being configured to act altruistically for the best interest of the network as a whole.

12. The system for distributing content of claim 11, wherein providing the peer-to-peer network includes configuring each node to act by favoring the stability of the network over its own performance interests.

13. The system for distributing content t of claim 11, further comprising providing video content for distribution using the peer-to-peer network and configuring at least one node to act by favoring the stability of the network over the performance interests of the at least one node.

14. The system for distributing content of claim 11, further comprising configuring at least one node to act by favoring the stability of the network rather than the direct self interest of the at least one node

15. A method of using download and upload data transfers in a distributed computing environment, comprising:
generating metrics that are used to shape future download and upload transactions/decisions in a manner that optimizes over the top (OTT) real time adaptive bit rate encoded multicast streaming video.

16. A method of claim 15, further comprising providing for “peer selection” in a dedicated peer-to-peer network where, among other factors, the selection is made favoring the least popular nodes, which are the least utilized by other peers on the network) to retrieve data from when one or more options are available.

17. A method of claim 15, further comprising providing a contrarian peer selection process is based primarily on a need or priority basis, whereby each node decides whether or not to prioritize the speed/power/quality of a connection to a node or to prioritize the popularit” of a node it is connecting to, wherein a node that has great need for speed/power/quality will proportionately ignore the popularity of its connecting node while a node that is in little need will proportionately avoid nodes with high popularit” or a high likeliness to be needed by others.

18. A method of claim 15, further comprising optimizing data redundancy and distribution on a network of dedicated hardware devices for the purposes of each device contributing to over the top real time variable bit rate multicast streaming video.

19. A method of claim 15, further comprising distributing new data across a network of dedicated computing devices using a process based on system metrics as described herein.

20. A method of claim 15, further comprising adding new data to a distributed cache in a peer-to-peer network when the shared cache of each node/peer is always maintained at full capacity and all new data must overwrite existing data, such that each node runs its own algorithm to mark items for deletion priority, but never preemptively deletes data until it receives new data to overwrite it with, wherein the node shares the information about the deletion priority of the data contained in its cache to the other nodes/peers on the network, such that when a node/peer adds new data to the distributed cache, the data is sent to the node/peer that has the data most ready to be deleted or overwritten.
